(19) United States
(12) Patent Application Publication
(10) Pub. No.: US 2016/0104067 A1
(43) Pub. Date: Apr. 14, 2016

(54) RECOMMENDATION PLATFORM

(71) Applicant: salesforce.com, inc., San Francisco, CA (US)

(72) Inventors: Zhenhua Xu, Stockholm (SE); Joel Palmert, Stockholm (SE); Johan Philip Magnusson, Stockholm (SE); Rasmus Mencke, San Francisco, CA (US); Scott Douglas White, Seattle, WA (US); Zandra Hird, Hagersten (SE); Ziwei Chen, Huddinge (SE); Kapil Agarwal, Newark, CA (US); Adam McCormick Doti, Petaluma, CA (US); Arthur Albert Louie, Vancouver (CA); Kamyar Seradjfar, Castro Valley, CA (US); Paul Gene Byrne, Seattle, WA (US); Runying Mao, Sammamish, WA (US); Weiping Peng, San Jose, CA (US)

(21) Appl. No.: 14/709,218

(22) Filed: May 11, 2015

Related U.S. Application Data
(60) Provisional application No. 62/061,573, filed on Oct. 8, 2014.

(51) Int. Cl. G06N 5/02; G06F 17/30; H04L 29/08

(52) U.S. Cl. CPC G06N 5/02; H04L 67/22; G06F 17/30864

(57) ABSTRACT

Disclosed are some examples of systems, apparatus, methods and storage media for providing customized recommendations to users. Some implementations more particularly relate to a recommendation platform that enables authorized third parties to create, customize and add new recommendations that are then available to be served to target users or audiences of users. Some implementations further relate to a recommendation platform that enables authorized users to define audiences, scheduling settings, scheduling policies, and rules to customize or influence the provision of associated recommendations to the users. The recommendation platform includes a recommendation engine that serves the recommendations to users based on such defined audiences, scheduling settings, policies or other rules.

### PRIORITY DATA

This application claims the benefit of priority under 35 U.S.C. §119(e) to U.S. Provisional Application No. 62/061,573 (Attorney Docket No. SLFCP182P/1504PROV) by Xu et al., titled RECOMMENDATIONS FOR USERS OF A DATABASE SYSTEM, filed on 8 Oct. 2014, which is hereby incorporated by reference in its entirety for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

This patent document relates generally to a recommendation platform, and more specifically, to a recommendation platform for providing customized recommendations to users.

### BACKGROUND

“Cloud computing” services provide shared resources, software, and information to computers and other devices upon request or on demand. Cloud computing typically involves the over-the-Internet provision of dynamically-scalable and often virtualized resources. Technological details can be abstracted from end-users, who no longer have need for expertise in, or control over, the technology infrastructure “in the cloud” that supports them. In cloud computing environments, software applications can be accessible over the Internet rather than installed locally on personal or in-house computer systems. Some of the applications or on-demand services provided to end-users can include the ability for a user to create, view, modify, store and share documents and other files.

### BRIEF DESCRIPTION OF THE DRAWINGS

The included drawings are for illustrative purposes and serve to provide examples of possible structures and operations for the disclosed inventive systems, apparatus, methods and computer-readable storage media. These drawings in no way limit any changes in form and detail that may be made by one skilled in the art without departing from the spirit and scope of the disclosed implementations.

FIG. 1A shows a block diagram of an example environment in which an on-demand database service can be used according to some implementations.

FIG. 1B shows a block diagram of example implementations of elements of FIG. 1A and example interconnections between these elements according to some implementations.

FIG. 2A shows a system diagram of example architectural components of an on-demand database service environment according to some implementations.

FIG. 2B shows a system diagram further illustrating example architectural components of an on-demand database service environment according to some implementations.

FIG. 3 shows an example of a web interface for a group page including a group feed for interacting with members of the group in an enterprise social network according to some implementations.

FIG. 4 shows an example of a web interface for a record page including a record feed for interacting with followers of the record in an enterprise social network according to some implementations.

FIG. 5 shows an example of a web interface for a user page including a user feed for interacting with other users of an enterprise social network according to some implementations.

FIG. 6 shows an example recommendation platform according to some implementations.

FIG. 7 shows example services provided by the APIs of the recommendation platform of FIG. 6 according to some implementations.

FIG. 8A shows an example of a user interface for enabling an authorized user to select to create a new recommendation or to select from a list of available existing recommendations.

FIG. 8B shows an example of the user interface of FIG. 8A after the recommendation definition of FIG. 9B has been added to the database.

FIG. 9A shows an example of a recommendation definition user interface for enabling an authorized user to create or customize a recommendation definition according to some implementations.

FIG. 9B shows an example of a customized recommendation definition after an authorized user has created or customized the recommendation definition using the user interface of FIG. 9A.

FIG. 10 shows an example of a user interface for enabling an authorized user to create or customize a rule definition according to some implementations.

FIG. 11 shows an example of a user interface for enabling an authorized user to associate recommendation definitions and rule definitions according to some implementations.

FIG. 12 shows a flow chart illustrating an example of a process for serving a recommendation to a user according to some implementations.

### DETAILED DESCRIPTION

Examples of systems, apparatus, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; for example, the phrase “A, B or C” is intended to include the possibilities of “A,” “B,” “C,” “A and B,” “B and C,” “A and C” and “A, B and C.”

Various implementations described and referenced herein are directed to database systems, computer-implemented methods and computer-readable storage media for serving recommendations. Some implementations relate to a recommendation platform for providing customized recommendations to users. Some implementations more particularly relate to a recommendation platform that enables authorized third parties to create, customize and add new recommendations that are then available to be served to target users or audiences of users. Some implementations further relate to a recommendation platform that enables authorized users to define audiences, scheduling settings, scheduling policies, and rules to customize or influence the provision of associated recommendations to the users. The recommendation platform includes a recommendation engine that serves the recommendations to users based on such defined audiences, scheduling settings, policies or other rules.

Generally, the recommendation platform can provide recommendations for virtually anything that an enterprise may desire to recommend to the target users. In a social networking context, the recommendation platform can enable authorized third parties to customize recommendations to be served to users suggesting other users the users may be interested in following, records the users may be interested in following, groups the users may be interested in subscribing to, or communities the users may be interesting in joining Additionally or alternatively, the recommendation platform can enable authorized third parties to customize recommendations for use in e-commerce applications, for example, recommendations suggesting products or services consumers may be interested in learning about or purchasing. Additionally or alternatively, the recommendation platform can enable authorized third parties to customize recommendations for use in educational, team-building or networking contexts, for example, recommendations suggesting events such as conferences, classes, seminars, webinars or activities the users may be interested in joining, attending or otherwise participating in.

Generally, the recommendation platform can enable authorized users to customize the generation, triggering and provision of recommendations based on virtually any action that occurs within or with respect to the database system. Such actions can include user-initiated actions (or “user actions”) such as the reception of a user input, for example, a user's clicking or other selection of a user interface (UI) element or a user's entering of text or other data into a data field. A recommendation also can be triggered by the act of a user logging into a database system or in response to the authentication of the user by the database system. The recommendation platform also can enable authorized users to customize how, where and when the recommendations are displayed or otherwise provided to the target users. Generally, the recommendations can be provided to the users via a variety of means; for example, as such users are visiting various websites, webpages, web applications or other web interfaces accessible to the users. In some implementations, various recommendations can be served as feed items in a social networking news feed.

Recommendations in an enterprise social networking system can advantageously serve an important role in connecting existing users of the social networking system, in engaging existing users, and in introducing new users to various other users, groups, records, and features of the social networking system as well as facilitating collaboration among both new and existing users. For example, analyses have shown that the more groups and users a user follows, the higher the user's engagement with the social networking system. In contrast, users following very few groups and few other users generally have low engagement. It has also been observed that a significant plurality or even a majority of new user connections in a social networking system can be directly attributed to recommendations provided to users.

It may be the case that an administrator of an organization or a manager of a community has better knowledge of the organization or community than, for example, the owner or operator of a database system that provides a platform for the organization or community. Generally, the administrator or manager can provide valuable insight on desirable recommendations for the employees, customers, partners or other target users internal or external to the organization. In some implementations, the recommendation platform can advantageously enable administrators, community managers or other third parties to add or customize recommendations in the recommendation platform for serving by the recommendation engine. For example, the recommendation platform can allow such third parties to configure one or more of the following: the content of recommendations, the actions or events that trigger the serving of the recommendations, the signals or criteria that define audiences of users to whom the recommendations are provided, the locations or channels by which the recommendations can be served and displayed, as well as scheduling settings for the recommendations.

In some implementations, the recommendation engine and platform can be integrated with other applications including third party applications. For example, a database system can provide an application enabling enterprise marketers to design and automate responsive campaigns that guide customers through steps of a business trip, vacation, or other “journey” (for example, Journey Builder by salesforce.com of San Francisco, Calif.). For example, when a new user joins and accesses the application, the recommendation engine can serve a recommendation to the new user. For example, the recommendation can be a welcome email. The recommendation platform also can include a rule definition specifying that, after an initial time period has lapsed (for example, one or more days), the recommendation platform is to add a second recommendation to a list of recommendations available for serving to the user. The rule also can indicate an action to take if the new user selects or accepts the second recommendation. For example, if the new user accepts the recommendation, the recommendation engine can serve the new user with a third recommendation, but if the new user does not accept the second recommendation, the recommendation engine can instead serve a fourth recommendation, or serve the third recommendation via a different communication medium. For example, if the second recommendation was a recommendation to join a group or community, and the new user selects to join the group or community, the third recommendation can be served as a feed item. The third recommendation can be, for example, a recommendation to view a profile associated with a member of the group or community. On the other hand, if the new user does not join the group or community, the fourth recommendation can be served via another channel, such as an email. For example, the fourth recommendation can be a recommendation for a different group or community. In other instances, the fourth recommendation can be a recommendation to try or purchase a product such as a cloud-based software application, a vacation trip package, or a tangible product such as a briefcase. In other instances, the fourth recommendation can be an invitation to attend a webinar or other event.

In some implementations, the customers, employees or other users described herein are users (or “members”) of an interactive online “enterprise social network,” also referred to herein as a “social networking system,” an “enterprise social networking system,” an “enterprise collaborative network,” or more simply as an “enterprise network.” Such online enterprise networks are increasingly becoming a common way to facilitate communication among people, any of whom can be recognized as enterprise users. One example of an online enterprise social network is Chatter®, provided by salesforce.com, inc. of San Francisco, Calif. salesforce.com, inc. is a provider of enterprise social networking services, customer relationship management (CRM) services and other database management services, any of which can be accessed and used in conjunction with the techniques disclosed herein in some implementations. These various services can be provided in a cloud computing environment as described herein, for example, in the context of a multi-tenant database system. Some of the described techniques or processes can be implemented without having to install software locally, that is, on computing devices of users interacting with services available through the cloud. While the disclosed implementations may be described with reference to Chatter® and more generally to enterprise social networking, those of ordinary skill in the art should understand that the disclosed techniques are neither limited to Chatter® nor to any other services and systems provided by salesforce.com, inc. and can be implemented in the context of various other database systems such as cloud-based systems that are not part of a multi-tenant database system or which do not provide enterprise social networking services.

I. Example System Overview

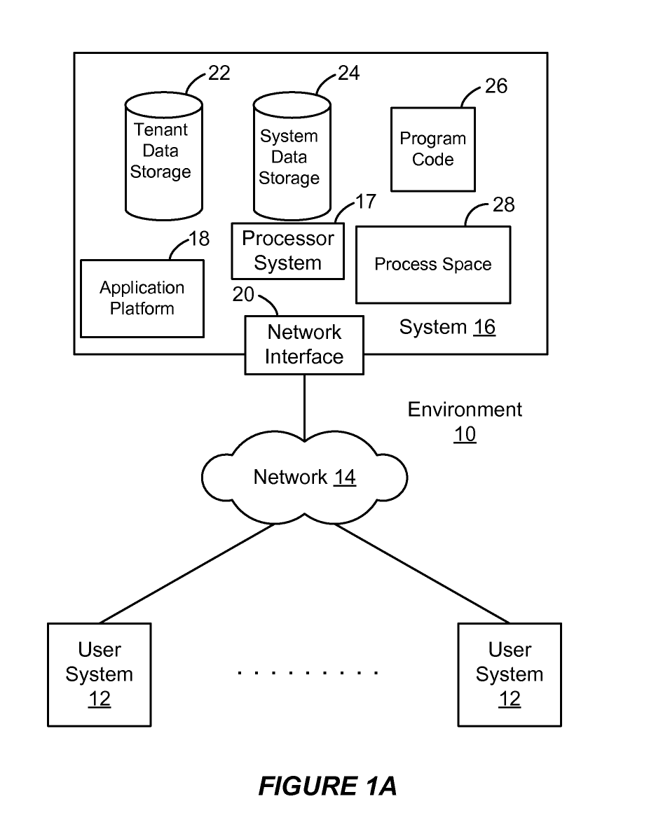

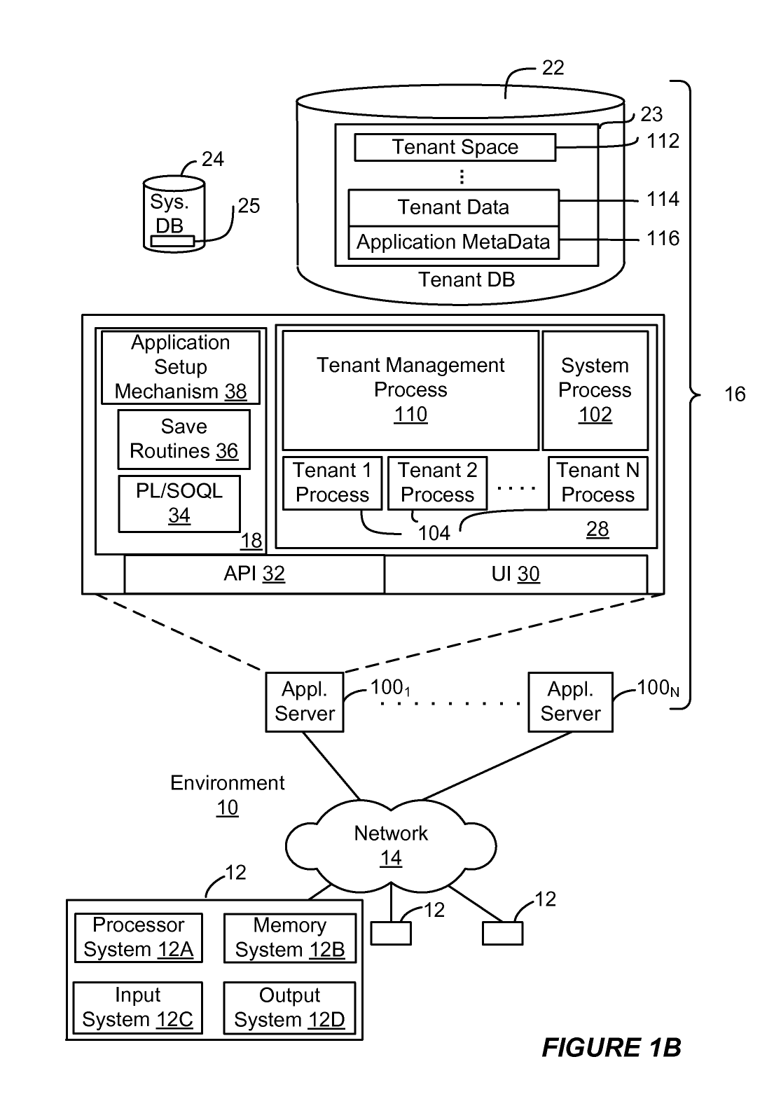

FIG. 1A shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the system 16, is a service that is made available to users outside of the enterprise(s) that own, maintain or provide access to the system 16. As described above, such users generally do not need to be concerned with building or maintaining the system 16. Instead, resources provided by the system 16 may be available for such users' use when the users need services provided by the system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 18 can be a framework that allows the applications of system 16 to execute, such as the hardware or software infrastructure of the system 16. In some implementations, the application platform 18 enables the creation, management and execution of one or more applications developed by the provider of the on-demand database service, users accessing the on-demand database service via user systems 12, or third party application developers accessing the on-demand database service via user systems 12.

In some implementations, the system 16 implements a web-based customer relationship management (CRM) system. For example, in some such implementations, the system 16 includes application servers configured to implement and execute CRM software applications as well as provide related data, code, forms, renderable web pages and documents and other information to and from user systems 12 and to store to, and retrieve from, a database system related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The system 16 also implements applications other than, or in addition to, a CRM application. For example, the system 16 can provide tenant access to multiple hosted (standard and custom) applications, including a CRM application. User (or third party developer) applications, which may or may not include CRM, may be supported by the application platform 18. The application platform 18 manages the creation and storage of the applications into one or more database objects and the execution of the applications in one or more virtual machines in the process space of the system 16.

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with system 16 using TCP/IP and, at a higher network level, other common Internet protocols to communicate, such as HTTP, FTP, AFS, WAP, etc. In an example where HTTP is used, each user system 12 can include an HTTP client commonly referred to as a “web browser” or simply a “browser” for sending and receiving HTTP signals to and from an HTTP server of the system 16. Such an HTTP server can be implemented as the sole network interface 20 between the system 16 and the network 14, but other techniques can be used in addition to or instead of these techniques. In some implementations, the network interface 20 between the system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 16) of the user system 12 to access, process and view information, pages and applications available to it from the system 16 over the network 14.

Each user system 12 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 12 in conjunction with pages, forms, applications and other information provided by the system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with the system 16, that user system can have the capacities allotted to the salesperson. However, while an administrator is using that user system 12 to interact with the system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “permission sets” or “authorizations”).

According to some implementations, each user system 12 and some or all of its components are operator-configurable using applications, such as a browser, including computer code executed using a central processing unit (CPU) such as an Intel Pentium® processor or the like. Similarly, the system 16 (and additional instances of an MTS, where more than one is present) and all of its components can be operator-configurable using application(s) including computer code to run using the processor system 17, which may be implemented to include a CPU, which may include an Intel Pentium® processor or the like, or multiple CPUs.

The system 16 includes tangible computer-readable media having non-transitory instructions stored thereon/in that are executable by or used to program a server or other computing system (or collection of such servers or computing systems) to perform some of the implementation of processes described herein. For example, computer program code 26 can implement instructions for operating and configuring the system 16 to intercommunicate and to process web pages, applications and other data and media content as described herein. In some implementations, the computer code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

FIG. 1B shows a block diagram of example implementations of elements of FIG. 1A and example interconnections between these elements according to some implementations. That is, FIG. 1B also illustrates environment 10, but FIG. 1B, various elements of the system 16 and various interconnections between such elements are shown with more specificity according to some more specific implementations. Additionally, in FIG. 1B, the user system 12 includes a processor system 12A, a memory system 12B, an input system 12C, and an output system 12D. The processor system 12A can include any suitable combination of one or more processors. The memory system 12B can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, the network interface 20 is implemented as a set of HTTP application (or “app”) servers 100₁-100_{N}. Each of the application servers 100₁-100_{N} (also referred to collectively herein as “the application server 100”) is configured to communicate with tenant database 22 and the tenant data 23 therein, as well as system database 24 and the system data 25 therein, to serve requests received from the user systems 12. The tenant data 23 can be divided into individual tenant storage spaces 112, which can be physically or logically arranged or divided. Within each tenant storage space 112, user storage 114 and application metadata 116 can similarly be allocated for each user. For example, a copy of a user's most recently used (MRU) items can be stored to user storage 114. Similarly, a copy of MRU items for an entire organization that is a tenant can be stored to tenant storage space 112.

The process space 28 includes system process space 102, individual tenant process spaces 104 and a tenant management process space 110. The application platform 18 includes an application setup mechanism 38 that supports application developers' creation and management of applications. Such applications and others can be saved as metadata into tenant database 22 by save routines 36 for execution by subscribers as one or more tenant process spaces 104 managed by tenant management process 110, for example. Invocations to such applications can be coded using PL/SOQL 34, which provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 116 for the subscriber making the invocation and executing the metadata as an application in a virtual machine.

The system 16 of FIG. 1B also includes a user interface (UI) 30 and an application programming interface (API) 32 to system 16 resident processes to users or developers at user systems 12. In some other implementations, the environment 10 may not have the same elements as those listed above or may have other elements instead of, or in addition to, those listed above.

Each application server 100 can be communicably coupled with tenant database 22 and system database 24, for example, having access to tenant data 23 and system data 25, respectively, via a different network connection. For example, one application server 100₁ can be coupled via the network 14 (for example, the Internet), another application server 100_{N-1} can be coupled via a direct network link, and another application server 100_{N} can be coupled by yet a different network connection. Transfer Control Protocol and Internet Protocol (TCP/IP) are examples of typical protocols that can be used for communicating between application servers 100 and the system 16. However, it will be apparent to one skilled in the art that other transport protocols can be used to optimize the system 16 depending on the network interconnections used.

In some implementations, each application server 100 is configured to handle requests for any user associated with any organization that is a tenant of the system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between the application servers 100 and the user systems 12 to distribute requests to the application servers 100. In one implementation, the load balancer uses a least-connections algorithm to route user requests to the application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, system 16 can be a multi-tenant system in which system 16 handles storage of, and access to, different objects, data and applications across disparate users and organizations.

In one example storage use case, one tenant can be a company that employs a sales force where each salesperson uses system 16 to manage aspects of their sales. A user can maintain contact data, leads data, customer follow-up data, performance data, goals and progress data, etc., all applicable to that user's personal sales process (for example, in tenant database 22). In an example of a MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 16 also can maintain system level data usable by multiple tenants or other data. Such system level data can include industry reports, news, postings, and the like that are sharable among tenants.

In some implementations, the user systems 12 (which also can be client systems) communicate with the application servers 100 to request and update system-level and tenant-level data from the system 16. Such requests and updates can involve sending one or more queries to tenant database 22 or system database 24. The system 16 (for example, an application server 100 in the system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

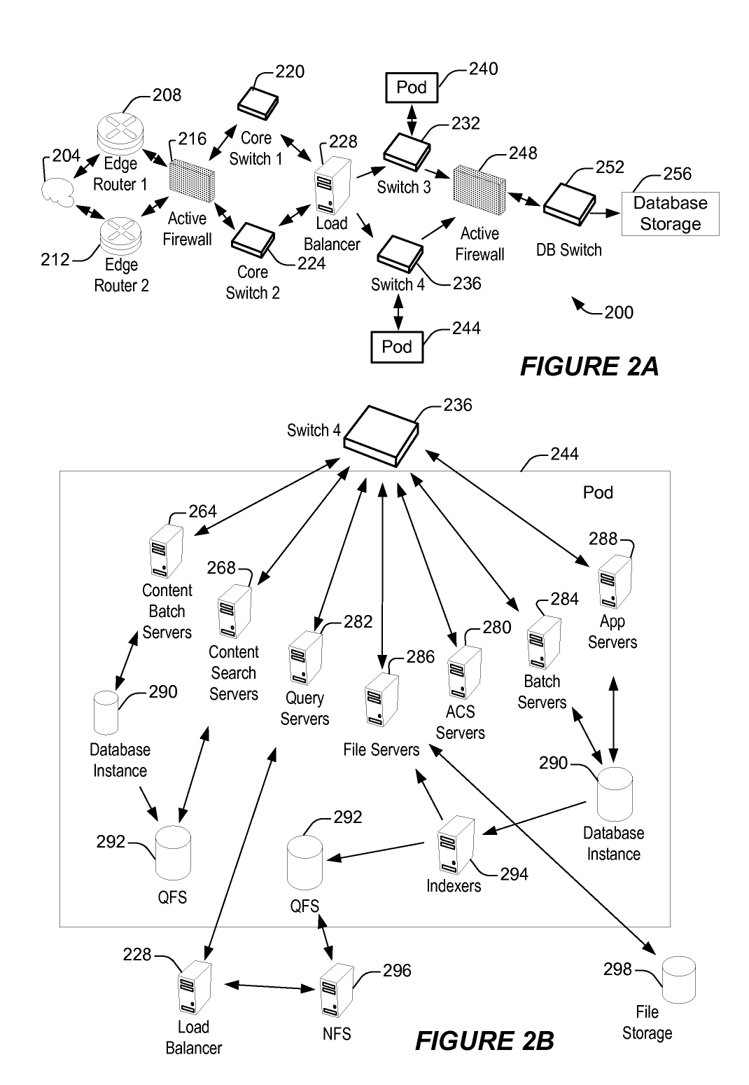

FIG. 2A shows a system diagram illustrating example architectural components of an on-demand database service environment 200 according to some implementations. A client machine communicably connected with the cloud 204, generally referring to one or more networks in combination, as described herein, can communicate with the on-demand database service environment 200 via one or more edge routers 208 and 212. A client machine can be any of the examples of user systems 12 described above. The edge routers can communicate with one or more core switches 220 and 224 through a firewall 216. The core switches can communicate with a load balancer 228, which can distribute server load over different pods, such as the pods 240 and 244. The pods 240 and 244, which can each include one or more servers or other computing resources, can perform data processing and other operations used to provide on-demand services. Communication with the pods can be conducted via pod switches 232 and 236. Components of the on-demand database service environment can communicate with database storage 256 through a database firewall 248 and a database switch 252.

As shown in FIGS. 2A and 2B, accessing an on-demand database service environment can involve communications transmitted among a variety of different hardware or software components. Further, the on-demand database service environment 200 is a simplified representation of an actual on-demand database service environment. For example, while only one or two devices of each type are shown in FIGS. 2A and 2B, some implementations of an on-demand database service environment can include anywhere from one to several devices of each type. Also, the on-demand database service environment need not include each device shown in FIGS. 2A and 2B, or can include additional devices not shown in FIGS. 2A and 2B.

Additionally, it should be appreciated that one or more of the devices in the on-demand database service environment 200 can be implemented on the same physical device or on different hardware. Some devices can be implemented using hardware or a combination of hardware and software. Thus, terms such as “data processing apparatus,” “machine,” “server” and “device” as used herein are not limited to a single hardware device, rather references to these terms can include any suitable combination of hardware and software configured to provide the described functionality.

The cloud 204 is intended to refer to a data network or multiple data networks, often including the Internet. Client machines communicably connected with the cloud 204 can communicate with other components of the on-demand database service environment 200 to access services provided by the on-demand database service environment. For example, client machines can access the on-demand database service environment to retrieve, store, edit, or process information. In some implementations, the edge routers 208 and 212 route packets between the cloud 204 and other components of the on-demand database service environment 200. For example, the edge routers 208 and 212 can employ the Border Gateway Protocol (BGP). The BGP is the core routing protocol of the Internet. The edge routers 208 and 212 can maintain a table of IP networks or ‘prefixes’, which designate network reachability among autonomous systems on the Internet.

In some implementations, the firewall 216 can protect the inner components of the on-demand database service environment 200 from Internet traffic. The firewall 216 can block, permit, or deny access to the inner components of the on-demand database service environment 200 based upon a set of rules and other criteria. The firewall 216 can act as one or more of a packet filter, an application gateway, a stateful filter, a proxy server, or any other type of firewall.

In some implementations, the core switches 220 and 224 are high-capacity switches that transfer packets within the on-demand database service environment 200. The core switches 220 and 224 can be configured as network bridges that quickly route data between different components within the on-demand database service environment. In some implementations, the use of two or more core switches 220 and 224 can provide redundancy or reduced latency.

In some implementations, the pods 240 and 244 perform the core data processing and service functions provided by the on-demand database service environment. Each pod can include various types of hardware or software computing resources. An example of the pod architecture is discussed in greater detail with reference to FIG. 2B. In some implementations, communication between the pods 240 and 244 is conducted via the pod switches 232 and 236. The pod switches 232 and 236 can facilitate communication between the pods 240 and 244 and client machines communicably connected with the cloud 204, for example via core switches 220 and 224. Also, the pod switches 232 and 236 may facilitate communication between the pods 240 and 244 and the database storage 256. In some implementations, the load balancer 228 can distribute workload between the pods 240 and 244. Balancing the on-demand service requests between the pods can assist in improving the use of resources, increasing throughput, reducing response times, or reducing overhead. The load balancer 228 may include multilayer switches to analyze and forward traffic.

In some implementations, access to the database storage 256 is guarded by a database firewall 248. The database firewall 248 can act as a computer application firewall operating at the database application layer of a protocol stack. The database firewall 248 can protect the database storage 256 from application attacks such as structure query language (SQL) injection, database rootkits, and unauthorized information disclosure. In some implementations, the database firewall 248 includes a host using one or more forms of reverse proxy services to proxy traffic before passing it to a gateway router. The database firewall 248 can inspect the contents of database traffic and block certain content or database requests. The database firewall 248 can work on the SQL application level atop the TCP/IP stack, managing applications' connection to the database or SQL management interfaces as well as intercepting and enforcing packets traveling to or from a database network or application interface.

In some implementations, communication with the database storage 256 is conducted via the database switch 252. The multi-tenant database storage 256 can include more than one hardware or software components for handling database queries. Accordingly, the database switch 252 can direct database queries transmitted by other components of the on-demand database service environment (for example, the pods 240 and 244) to the correct components within the database storage 256. In some implementations, the database storage 256 is an on-demand database system shared by many different organizations as described above with reference to FIGS. 1A and 1B.

FIG. 2B shows a system diagram further illustrating example architectural components of an on-demand database service environment according to some implementations. The pod 244 can be used to render services to a user of the on-demand database service environment 200. In some implementations, each pod includes a variety of servers or other systems. The pod 244 includes one or more content batch servers 264, content search servers 268, query servers 282, file force servers 286, access control system (ACS) servers 280, batch servers 284, and app servers 288. The pod 244 also can include database instances 290, quick file systems (QFS) 292, and indexers 294. In some implementations, some or all communication between the servers in the pod 244 can be transmitted via the switch 236.

In some implementations, the app servers 288 include a hardware or software framework dedicated to the execution of procedures (for example, programs, routines, scripts) for supporting the construction of applications provided by the on-demand database service environment 200 via the pod 244. In some implementations, the hardware or software framework of an app server 288 is configured to execute operations of the services described herein, including performance of the blocks of various methods or processes described herein. In some alternative implementations, two or more app servers 288 can be included and cooperate to perform such methods, or one or more other servers described herein can be configured to perform the disclosed methods.

The content batch servers 264 can handle requests internal to the pod. Some such requests can be long-running or not tied to a particular customer. For example, the content batch servers 264 can handle requests related to log mining, cleanup work, and maintenance tasks. The content search servers 268 can provide query and indexer functions. For example, the functions provided by the content search servers 268 can allow users to search through content stored in the on-demand database service environment. The file force servers 286 can manage requests for information stored in the Fileforce storage 298. The Fileforce storage 298 can store information such as documents, images, and basic large objects (BLOBs). By managing requests for information using the file force servers 286, the image footprint on the database can be reduced. The query servers 282 can be used to retrieve information from one or more file systems. For example, the query system 282 can receive requests for information from the app servers 288 and transmit information queries to the NFS 296 located outside the pod.

The pod 244 can share a database instance 290 configured as a multi-tenant environment in which different organizations share access to the same database. Additionally, services rendered by the pod 244 may call upon various hardware or software resources. In some implementations, the ACS servers 280 control access to data, hardware resources, or software resources. In some implementations, the batch servers 284 process batch jobs, which are used to run tasks at specified times. For example, the batch servers 284 can transmit instructions to other servers, such as the app servers 288, to trigger the batch jobs.

In some implementations, the QFS 292 is an open source file system available from Sun Microsystems® of Santa Clara, Calif. The QFS can serve as a rapid-access file system for storing and accessing information available within the pod 244. The QFS 292 can support some volume management capabilities, allowing many disks to be grouped together into a file system. File system metadata can be kept on a separate set of disks, which can be useful for streaming applications where long disk seeks cannot be tolerated. Thus, the QFS system can communicate with one or more content search servers 268 or indexers 294 to identify, retrieve, move, or update data stored in the network file systems 296 or other storage systems.

In some implementations, one or more query servers 282 communicate with the NFS 296 to retrieve or update information stored outside of the pod 244. The NFS 296 can allow servers located in the pod 244 to access information to access files over a network in a manner similar to how local storage is accessed. In some implementations, queries from the query servers 282 are transmitted to the NFS 296 via the load balancer 228, which can distribute resource requests over various resources available in the on-demand database service environment. The NFS 296 also can communicate with the QFS 292 to update the information stored on the NFS 296 or to provide information to the QFS 292 for use by servers located within the pod 244.

In some implementations, the pod includes one or more database instances 290. The database instance 290 can transmit information to the QFS 292. When information is transmitted to the QFS, it can be available for use by servers within the pod 244 without using an additional database call. In some implementations, database information is transmitted to the indexer 294. Indexer 294 can provide an index of information available in the database 290 or QFS 292. The index information can be provided to file force servers 286 or the QFS 292.

II. Enterprise Social Networking

As described above, in some implementations the database system 16 includes application servers 100₁-100_{N} that can implement or host one or more applications or platforms for providing various on-demand or cloud-computing features or services described herein. In some implementations, one or more of the application servers 100₁-100_{N} implement or host an enterprise social networking platform. In some implementations, the enterprise social networking platform enables each tenant of the database system 16 to create, customize, build or access an enterprise social network for use by users of the respective organization (tenant).

Enterprise social networks can be implemented in various settings, including businesses, organizations and other enterprises (all of which are used interchangeably herein). For instance, an enterprise social network can be implemented to connect users within a business corporation, partnership or organization, or a group of users within such an enterprise. For instance, Chatter® can be used by users who are employees in a business organization to share data, communicate, and collaborate with each other for various enterprise-related purposes. Some of the disclosed methods, processes, devices, systems and computer-readable storage media described herein can be configured or designed for use in a multi-tenant database environment, such as described above with respect to database system 16. In an example implementation, each organization or a group within the organization can be a respective tenant of the system.

In some implementations, each user of the database system 16 is associated with a “user profile.” A user profile refers generally to a collection of data about a given user. The data can include general information, such as a name, a title, a phone number, a photo, a biographical summary, or a status (for example, text describing what the user is currently doing, thinking or expressing). The data associated with a user profile also can include various permissions defining the ability of the user to interact with various data objects. In implementations in which there are multiple tenants, a user is typically associated with a particular tenant (or “organization”). For example, a user could be a salesperson of an organization that is a tenant of the database system 16.

A “group” generally refers to a collection of users within an organization. In some implementations, a group can be defined as users with the same or a similar attribute, or by membership or subscription. Groups can have various visibilities to users within an enterprise social network. For example, some groups can be private while others can be public. In some implementations, to become a member within a private group, and to have the capability to publish and view feed items on the group's group feed, a user must request to be subscribed to the group (and be accepted by, for example, an administrator or owner of the group), be invited to subscribe to the group (and accept), or be directly subscribed to the group (for example, by an administrator or owner of the group). In some implementations, any user within the enterprise social network can subscribe to or follow a public group (and thus become a “member” of the public group) within the enterprise social network.

In some implementations, a “community” refers to a collection of one or more users within an organization that is a tenant of the database system 16 and one or more persons or enterprises outside of the organization that may or may not necessarily be tenants of the database system 16. For example, a community can enable users of an organization to connect with various partners outside of the organization including various third-party partners outside of the social networking system to facilitate one or more shared goals, objectives, or activities. For example, such partners can include distributors, resellers and suppliers, among other desirable partners. In some implementations, multiple communities can be created for or by an organization for different purposes and for connecting or collaborating with different partners. In some implementations, a community also can have a community feed.

A “record” generally refers to a data entity, such as an instance of a data object created by a user or a group of users of the database system 16. Such records can include, for example, data objects representing and maintaining data for accounts (for example, representing a business relationship with another enterprise). In some implementations, each record is assigned a record type, which can be identified by a RecordTypelD. Examples of account record types include: customers (for example, users or organizations who pay the enterprise money), customer support (for example, users or organizations who pay the enterprise money to support them), households (for example, organizations in a business-to-consumer model), partners (for example, organizations who pay the enterprise money and to whom the enterprise pays money), suppliers (for example, organizations to whom the enterprise pays money), and other organizations including organizations with whom no money is exchanged. Other examples of record types in addition to accounts can include cases, opportunities, leads, projects, contracts, orders, pricebooks, products, solutions, reports and forecasts, among other possibilities.

For example, an account record can be for a business partner or potential business partner, an actual or potential customer, an actual or potential supplier, an actual or potential distributor, or a client, among other possibilities. A record such as an account can include information describing an entire enterprise or subsidiary of an enterprise. As another example, a record such as an account record itself can include a number of records. For example, a customer account can include opportunities, contracts, and orders. As another example, a partner record can include a project or contract that a user or group of users is working on with an existing partner, or a project or contract that the user is trying to obtain with a partner. A record also can include various data fields and controls that are defined by the structure or layout of the object (for example, fields of certain data types and purposes). A record also can have custom fields defined by a user or organization. A field can include (or include a link to) another record, thereby providing a parent-child relationship between the records.

Records also can have various visibilities to users within an enterprise social network. For example, some records can be private while others can be public. In some implementations, to access a private record, and to have the capability to publish and view feed items on the record's record feed, a user must request to be subscribed to the record (and be accepted by, for example, an administrator or owner of the record), be invited to subscribe to the record (and accept), be directly subscribed to the record or be shared the record (for example, by an administrator or owner of the record). In some implementations, any user within the enterprise social network can subscribe to or follow a public record within the enterprise social network.

In some online enterprise social networks, users also can follow one another by establishing “links” or “connections” with each other, sometimes referred to as “friending” one another. By establishing such a link, one user can see information generated by, generated about, or otherwise associated with another user. For instance, a first user can see information posted by a second user to the second user's profile page. In one example, when the first user is following the second user, the first user's news feed can receive a post from the second user submitted to the second user's profile feed.

In some implementations, users can access one or more enterprise network feeds (also referred to herein simply as “feeds”), which include publications presented as feed items or entries in the feed. A network feed can be displayed in a graphical user interface (GUI) on a display device such as the display of a user's computing device as described above. The publications can include various enterprise social network information or data from various sources and can be stored in the database system 16, for example, in tenant database 22. In some implementations, feed items of information for or about a user can be presented in a respective user feed, feed items of information for or about a group can be presented in a respective group feed, and feed items of information for or about a record can be presented in a respective record feed. A second user following a first user, a first group, or a first record can automatically receive the feed items associated with the first user, the first group or the first record for display in the second user's news feed. In some implementations, a user feed also can display feed items from the group feeds of the groups the respective user subscribes to, as well as feed items from the record feeds of the records the respective user subscribes to.

The term “feed item” (or feed element) refers to an item of information, which can be viewable in a feed. Feed items can include publications such as messages (for example, user-generated textual posts or comments), files (for example, documents, audio data, image data, video data or other data), and “feed-tracked” updates associated with a user, a group or a record (feed-tracked updates are described in greater detail below). A feed item, and a feed in general, can include combinations of messages, files and feed-tracked updates. Documents and other files can be included in, linked with, or attached to a post or comment. For example, a post can include textual statements in combination with a document. The feed items can be organized in chronological order or another suitable or desirable order (which can be customizable by a user) when the associated feed is displayed in a graphical user interface (GUI), for instance, on the user's computing device.

Messages such as posts can include alpha-numeric or other character-based user inputs such as words, phrases, statements, questions, emotional expressions, or symbols. In some implementations, a comment can be made on any feed item. In some implementations, comments are organized as a list explicitly tied to a particular feed item such as a feed-tracked update, post, or status update. In some implementations, comments may not be listed in the first layer (in a hierarchal sense) of feed items, but listed as a second layer branching from a particular first layer feed item (such as a feed-tracked update, post, or status update). In some implementations, a “like” or “dislike” also can be submitted in response to a particular post, comment or other publication.

A “feed-tracked update,” also referred to herein as a “feed update,” is another type of publication that may be presented as a feed item and generally refers to data representing an event. A feed-tracked update can include text generated by the database system in response to the event, to be provided as one or more feed items for possible inclusion in one or more feeds. In one implementation, the data can initially be stored by the database system in, for example, tenant database 22, and subsequently used by the database system to create text for describing the event. Both the data and the text can be a feed-tracked update, as used herein. In some implementations, an event can be an update of a record and can be triggered by a specific action by a user. Which actions trigger an event can be configurable. Which events have feed-tracked updates created and which feed updates are sent to which users also can be configurable. Messages and feed updates can be stored as a field or child object of a record. For example, the feed can be stored as a child object of the record.

As described above, a network feed can be specific to an individual user of an online social network. For instance, a user news feed (or “user feed”) generally refers to an aggregation of feed items generated for a particular user, and in some implementations, is viewable only to the respective user on a home page of the user. In some implementations a user profile feed (also referred to as a “user feed”) is another type of user feed that refers to an aggregation of feed items generated by or for a particular user, and in some implementations, is viewable only by the respective user and other users following the user on a profile page of the user. As a more specific example, the feed items in a user profile feed can include posts and comments that other users make about or send to the particular user, and status updates made by the particular user. As another example, the feed items in a user profile feed can include posts made by the particular user and feed-tracked updates initiated based on actions of the particular user.

As is also described above, a network feed can be specific to a group of enterprise users of an online enterprise social network. For instance, a group news feed (or “group feed”) generally refers to an aggregation of feed items generated for or about a particular group of users of the database system 16 and can be viewable by users following or subscribed to the group on a profile page of the group. For example, such feed items can include posts made by members of the group or feed-tracked updates about changes to the respective group (or changes to documents or other files shared with the group). Members of the group can view and post to a group feed in accordance with a permissions configuration for the feed and the group. Publications in a group context can include documents, posts, or comments. In some implementations, the group feed also includes publications and other feed items that are about the group as a whole, the group's purpose, the group's description, a status of the group, and group records and other objects stored in association with the group. Threads of publications including updates and messages, such as posts, comments, likes, etc., can define conversations and change over time. The following of a group allows a user to collaborate with other users in the group, for example, on a record or on documents or other files (which may be associated with a record).

As is also described above, a network feed can be specific to a record in an online enterprise social network. For instance, a record news feed (or “record feed”) generally refers to an aggregation of feed items about a particular record in the database system 16 and can be viewable by users subscribed to the record on a profile page of the record. For example, such feed items can include posts made by users about the record or feed-tracked updates about changes to the respective record (or changes to documents or other files associated with the record). Subscribers to the record can view and post to a record feed in accordance with a permissions configuration for the feed and the record. Publications in a record context also can include documents, posts, or comments. In some implementations, the record feed also includes publications and other feed items that are about the record as a whole, the record's purpose, the record's description, and other records or other objects stored in association with the record. Threads of publications including updates and messages, such as posts, comments, likes, etc., can define conversations and change over time. The following of a record allows a user to track the progress of that record and collaborate with other users subscribing to the record, for example, on the record or on documents or other files associated with the record.

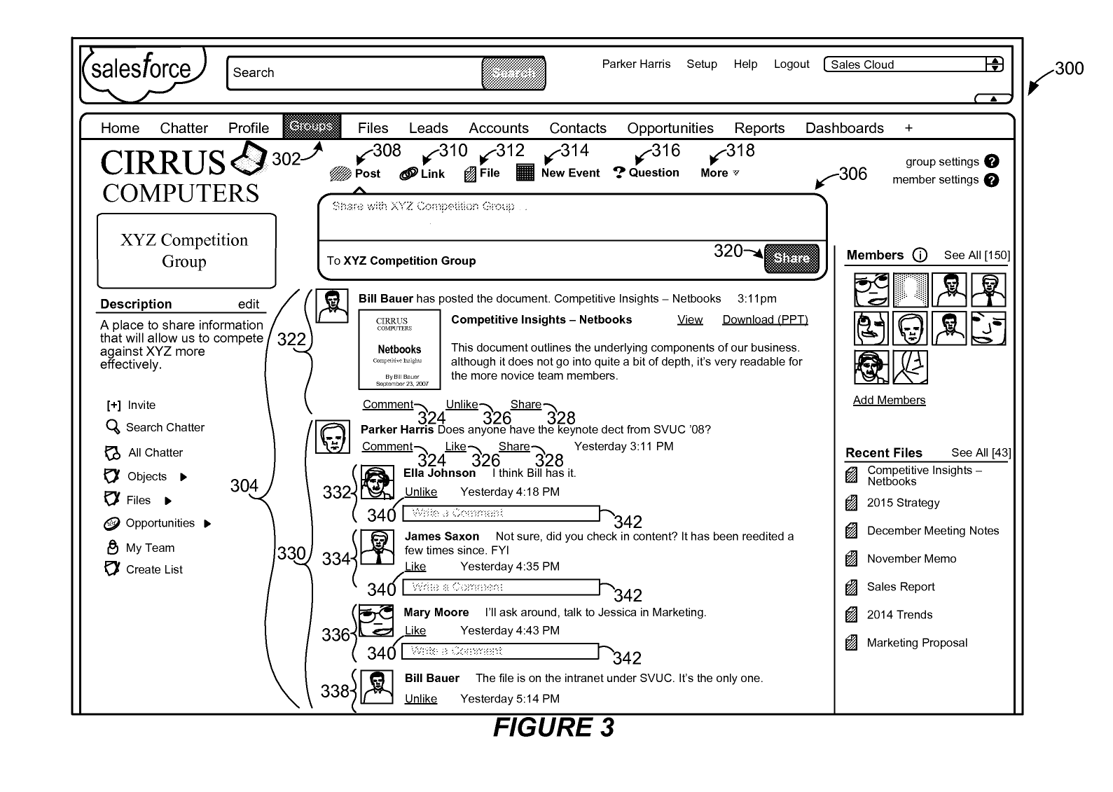

FIG. 3 shows an example of a web interface 300 for a group page including a group feed for interacting with members of the group in an enterprise social network according to some implementations. For example, the database system 16 can generate the interface 300 and transmit it to a user's computer (for example, as an HTML structured document) over one or more networks for rendering by a web browser or other rendering engine executing within the user's computer. The interface 300 can include multiple primary tabs for accessing various information or data. The primary tabs include a Groups tab 302 that, when “clicked” or otherwise selected by a user (as is the case in FIG. 3), opens a page displaying various information or UI elements for a group (or groups) in a section or area below the primary tabs.

The primary tabs of the interface 300 can be customizable by a user or by an administrator for the user's organization. For example, the primary tabs of the interface also can include a Home tab that opens the user's home page, a Chatter® tab that displays Chatter®-related information includes a personal news feed, a Profile tab that opens the user's profile page, a Files tab that opens a page displaying various information or UI elements associated with the file records the user owns or is subscribed to. Other primary tabs can include a Leads tab, an Accounts tab, an Opportunities tab, a Reports tab, a Dashboard tab, and a Contacts tab (in some implementations, the contacts are third-party contacts that are not registered users of the enterprise social network). Depending on which of the primary tabs described above is selected, the interface 300 can include one or more sub-tabs, buttons, links or other UI elements that can be selected to facilitate collaboration or the completion of a workflow.

As just described, the Groups tab 302 is selected in FIG. 3. In the illustrated example, the interface 300 displays a group page for the group “XYZ Competitive Group.” The interface 300 includes a group feed 304 for the group in a section below the primary tabs. The interface 300 includes a publication window 306 at a top portion of the group feed 304 that enables the user to submit a publication to the group feed. In the illustrated example implementation, the user can select a format or context for the publication by selecting the “Post” sub-tab 308, the “Link” sub-tab 310, the “File” sub-tab 312, a “New Event” sub-tab 314 or the “Question” sub-tab 316 or a “More” sub-tab 318. The arrangement of the publication window 306 and the number and function of various UI elements displayed in the publication window 306 can be tailored to a specific type of publication depending on which of the sub-tabs is selected to facilitate the publication. For example, the Post sub-tab 308 (selected in the illustrated example) enables the user to enter content in the form of text in the publication window 306. The user can also elect to reference other users, groups or records by, for example, @-mentioning such users, groups or records. The user can submit (publish) the publication by selecting a “Share” button 320. As another example, the Link sub-tab 310 enables the user to publish a link such as a URL or other address to the feed (note that this instance of the term “link” is not to be used interchangeably with the terms “subscription,” “association,” or “following” or other derivations or conjugations of these terms as described above). As another example, the File sub-tab 312 enables a user to publish a file to the feed as well as to enter text describing the file or otherwise relating to the file. As another example, the New Event sub-tab 314 enables the user to share an event invitation or to describe an event. As another example, the Question sub-tab 316 enables a user to publish a question. In some implementations, a published question can be distinguished from a normal post by the manner the question is displayed in a feed item or by the manner in which other users are notified of its publication. Furthermore, the More sub-tab 320 can allow a user to perform or cause other actions. For example, upon a user selecting the More sub-tab 320, a drop-down menu or pick list can be displayed below providing the user with selectable options or actions the user can choose.

As shown, the group feed 304 includes feed items published by other users. For example, the group feed 304 includes a first feed item 322 that includes a file and a related description published by the user “Bill Bauer.” As shown, the user viewing the group feed 304 can select to comment on the publication, like the publication or share the publication via Comment, Like and Share buttons or links 324, 326, and 328, respectively. For example, when the user selects the Comment link 324, a comment window can be displayed in the feed item 322 in an area below the original publication. In some implementations, after the user viewing the group feed 304 has selected to “like” the publication via the Like link 326, the Like link can be transformed to an “Unlike” link enabling the user to unlike the publication. In some implementations, after a user selects the Share link 328, a pop-up window can be displayed enabling the user to select other users, groups or records for which to share the feed item 322. Also shown in the group feed is a second feed item 330 that includes a post published by the user “Parker Harris.” As shown, other users, including Ella Johnson, James Saxon, Mary Moore and Bill Bauer have submitted comments 332, 334, 336 and 338, respectively, on the publication submitted by Parker Harris. In some implementations, the user viewing the group feed 304 can like the individual comments via Like links 340 or comment on individual comments via comment fields 342.

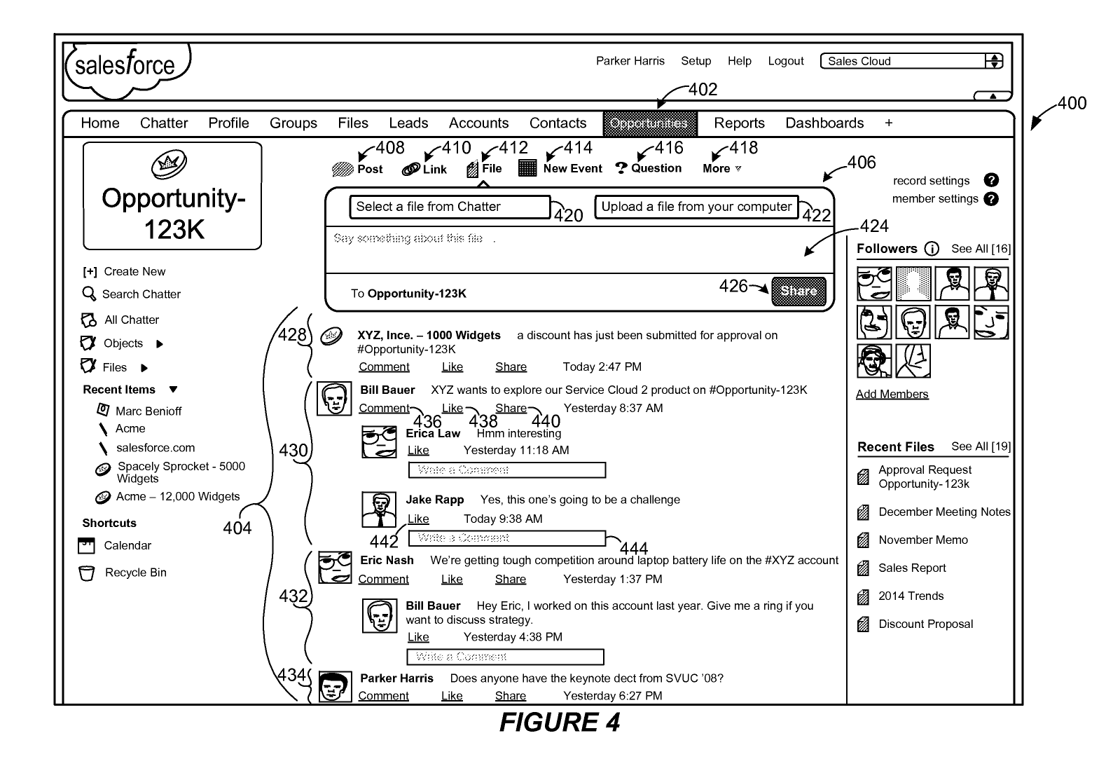

FIG. 4 shows an example of a web interface 400 for a record page including a record feed for interacting with followers of the record in an enterprise social network according to some implementations. The Opportunities tab 402 is selected in FIG. 4. In the illustrated example, the interface 400 displays an opportunity page (a type of record page) for the opportunity “Opportunity-123K.” The interface 400 includes a record feed 404 for the opportunity in a section below the primary tabs. The interface 400 includes a publication window 406 at a top portion of the record feed 404 that enables the user to submit a publication to the record feed. In the illustrated example implementation, the user can select a format or context for the publication by selecting a Post sub-tab 408, a Link sub-tab 410, a File sub-tab 412, a New Event sub-tab 414, a Question sub-tab 416 or a More sub-tab 418. As described above with reference to the group feed 404 of FIG. 4, the arrangement of the publication window 406 and the number and function of various UI elements displayed in the publication window 406 can be tailored to a specific type of publication depending on which of the sub-tabs is selected to facilitate the publication. In the illustrated example, the File sub-tab 412 is selected. The user can select a file to include in the publication via elements 420 or 422. The user also can add a description of the file or other information about the file in a body field 424. The user can also elect to reference other users, groups or records by, for example, @-mentioning such users, groups or records. The user can submit (publish) the publication by selecting a “Share” button 426.

As shown, the record feed 404 includes feed items published by other users. For example, the record feed 404 includes a number of feed items 428, 430, 432 and 434. Similar to the group feed 304 shown and described with reference to FIG. 3, the user viewing the record feed 404 can select to comment on the publications, like the publications or share the publications via Comment, Like and Share buttons or links 436, 438, and 440, respectively. As also described above, the user viewing the record feed 404 can like the individual comments via Like links 442 or comment on individual comments via comment fields 444.

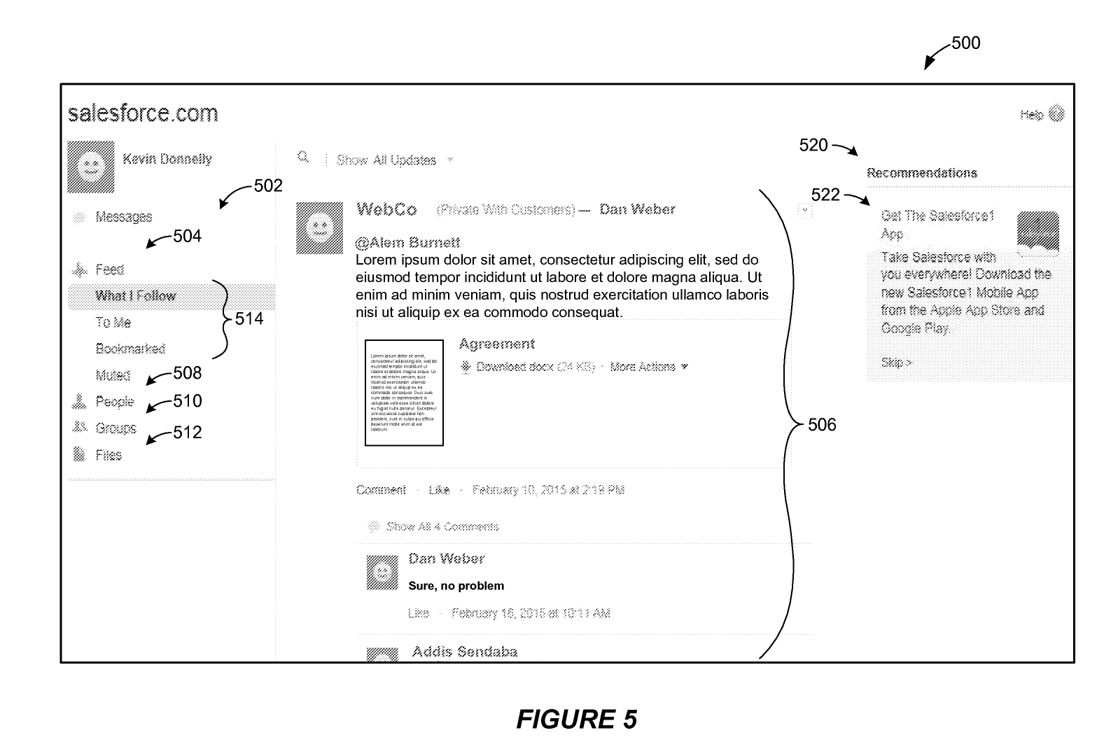

FIG. 5 shows an example of a web interface 500 for a user page including a user feed for interacting with other users of an enterprise social network according to some implementations. The interface 500 includes a section 502 in which the user can select various information to view in the interface 500. For example, the user can select a “Feed” button or tab 504 to view a user feed 506, a “People” button 508 to view other users the user follows or who follow the user, a “Groups” button 510 to view Groups the user is a member of, a “Files” button 512 to view files the user has created, edited, used or otherwise has access to. In the illustrated example, the Feed button 504 is selected resulting in the display of the user feed 506. In some implementations, when the Feed button 504 is selected, a picklist 514 of various filters can be displayed below the Feed button 504 enabling the user to filter the feed items to be displayed in the user feed 506. For example, the user can select a “What I Follow” filter (currently selected in the illustrated example) to view feed items associated with other users, groups and records the user subscribes to. The user also can select other filters such as a “To Me” filter to view feed items shared with or otherwise targeted to the user, a “Bookmarked” filter to view feed items that the user has selected to bookmark, and an “All Company” filter to view all of the feed items for the entire organization. The web interface 500 also includes a “Recommendations” section 520 that can display one or more recommendations to the user. In the illustrated example, the Recommendations section 520 displays a recommendation 520 suggestion an application that the user may be interested in learning more about or purchasing. In some implementations, the Recommendations section 520 also can display other users the user may be interested in following, groups the user may be interested in subscribing to, communities the user may be interesting in joining, other products or services the user may be interested in learning about or purchasing, as well as events (for example, conferences, classes, seminars, webinars or activities) the user may be interested in joining, attending or otherwise participating in.

III. Enterprise Social Networking Architecture

In some implementations, data is stored in database system 16, including tenant database 22, in the form of “entity objects” (also referred to herein simply as “entities”). In some implementations, entities are categorized into “Records objects” and “Collaboration objects.” In some such implementations, the Records object includes all records in the enterprise social network. Each record can be considered a sub-object of the overarching Records object. In some implementations, Collaboration objects include, for example, a “Users object,” a “Groups object,” a “Group-User relationship object,” a “Record-User relationship object” and a “Feed Items object.”

In some implementations, the Users object is a data structure that can be represented or conceptualized as a “Users Table” that associates users to information about or pertaining to the respective users including, for example, metadata about the users. In some implementations, the Users Table includes all of the users within an organization. In some other implementations, there can be a Users Table for each division, department, team or other sub-organization within an organization. In implementations in which the organization is a tenant of a multi-tenant enterprise social network platform, the Users Table can include all of the users within all of the organizations that are tenants of the multi-tenant enterprise social network platform. In some implementations, each user can be identified by a user identifier (“UserID”) that is unique at least within the user's respective organization. In some such implementations, each organization also has a unique organization identifier (“OrgID”).

In some such implementations, each row of the Users Table represents a unique user. Each row can include an OrgID in a first column, a user identifier UserID in a second column, and various information about the user in one or more additional columns. For example, a third column can include an identification of a user type (for example, a standard user or a portal user), a fourth column can include the user's actual name or screen name, a fifth column can include the user's email address, and a sixth column can include a password. In some alternative implementations, these or additional columns can include other information about or pertaining to the users.

In some implementations, the Groups object is a data structure that can be represented or conceptualized as a “Groups Table” that associates groups to information about or pertaining to the respective groups including, for example, metadata about the groups. In some implementations, the Groups Table includes all of the groups within the organization. In some other implementations, there can be a Groups Table for each division, department, team or other sub-organization within an organization. In implementations in which the organization is a tenant of a multi-tenant enterprise social network platform, the Groups Table can include all of the groups within all of the organizations that are tenants of the multitenant enterprise social network platform. In some implementations, each group can be identified by a group identifier (“GroupID”) that is unique at least within the respective organization.

In some such implementations, each row of the Groups Table represents a unique group. Each row can include an OrgID in a first column, a GroupID in a second column, and various information about the group in one or more additional columns. For example, a third column can include a group type (for example, an identification of whether the group is public or private), a fourth column can include a name or title of the group, a fifth column can include a UserID associated with the owner of the group (for example, the user that created the group), a sixth column can include information about the group (for example, a short description of a membership characteristic such as a purpose, objective or other relating quality of the members), and a seventh column can include a description of the group (for example, a longer description of the group's purpose or objective and membership characteristics). In some implementations, the information or description can include clickable or otherwise selectable textual or other user interface (UI) elements (for example, hyperlinks) that direct the user to the respective page associated with the selected element. In some alternative implementations, these or additional columns can include other information about or pertaining to the groups.

In some implementations, communities are stored as specialized groups within the Groups Table. In some other implementations, communities are stored in a separate Communities Table and have unique CommunityIDs.

In some implementations, the database system 16 includes a “Group-User relationship object.” The Group-User relationship object is a data structure that can be represented or conceptualized as a “Group-User Table” that associates groups to users subscribed to the respective groups. In some implementations, the Group-User Table includes all of the groups within the organization. In some other implementations, there can be a Group-User Table for each division, department, team or other sub-organization within an organization. In implementations in which the organization is a tenant of a multi-tenant enterprise social network platform, the Group-User Table can include all of the groups within all of the organizations that are tenants of the multitenant enterprise social network platform.

In some such implementations, each row of the Group-User Table represents a defined relationship, association, link or subscription (all of which are used interchangeably herein where appropriate) between a particular group and users subscribed to the group. Each row can include an OrgID in a first column, a GroupID in a second column, and at least one UserID in one or more third columns. Thus, each row defines a subscription relationship in which a user identified by a UserID in the third column is subscribed to the group identified by the GroupID in the second column, and in which the group identified by the GroupID in the second column is within the organization identified by the OrgID in the first column of the same row. In some alternative implementations, additional columns can include other information about or pertaining to the subscriptions between the users and groups.

In some implementations, the Records object is a data structure that can be represented or conceptualized as a “Records Table” that associates records to information about or pertaining to the respective records including, for example, metadata about the records. In some implementations, the Records Table includes all of the records within the organization. In some other implementations, there can be a Records Table for each division, department, team or other sub-organization within an organization. In implementations in which the organization is a tenant of a multi-tenant enterprise social network platform, the Records Table can include all of the records within all of the organizations that are tenants of the multitenant enterprise social network platform. In some implementations, each record can be identified by a record identifier (“RecordID”) that is unique at least within the respective organization.

In some such implementations, each row of the Records Table represents a unique record. Each row can include an OrgID in a first column, a RecordID in a second column, and various information about the record in one or more additional columns. For example, a third column can include a record type, a fourth column can include a name or title of the record and a fifth column can include the owner or creator of the record. In some alternative implementations, these or additional columns can include other information about or pertaining to the records.

In some implementations, the database system 16 includes a “Record-User relationship object.” The Record-User relationship object is a data structure that can be represented or conceptualized as a “Record-User Table” that associates records to users subscribed to the respective records. In some implementations, the Record-User Table includes all of the records within the organization. In some other implementations, there can be a Record-User Table for each division, department, team or other sub-organization within an organization. In implementations in which the organization is a tenant of a multi-tenant enterprise social network platform, the Record-User Table can include all of the records within all of the organizations that are tenants of the multitenant enterprise social network platform.

In some such implementations, each row of the Record-User Table represents a subscription between a particular record and users subscribed to the record. Each row can include an OrgID in a first column, a RecordID in a second column, and at least one UserID in one or more third columns. Thus, each row defines a subscription relationship in which a user identified by a UserID in the third column is subscribed to the record identified by the RecordID in the second column, and in which the record identified by the RecordID in the second column is within the organization identified by the OrgID in the first column of the same row. In some alternative implementations, additional columns can include other information about or pertaining to the subscriptions between the users and records.

In some implementations, the database system 16 includes a “Feed Items object.” The Feed items object is a data structure that can be represented or conceptualized as a “Feed Items Table” that associates users, records and groups to posts, comments, files or other publications to be displayed as feed items in the respective user feeds, record feeds and group feeds, respectively. In some implementations, the Feed Items Table includes all of the feed items within the organization. In some other implementations, there can be a Feed Items Table for each division, department, team or other sub-organization within an organization. In implementations in which the organization is a tenant of a multi-tenant enterprise social network platform, the Feed Items Table can include all of the feed items within all of the organizations that are tenants of the multitenant enterprise social network platform.

In some such implementations, each row of the Feed Items Table represents a defined relationship or link between a particular feed item and an associated user, record or group. Each row can include an OrgID in a first column, a FeedItemID in a second column, a UserID of the publishing user or owner of the feed item (for example, the user that submitted the publication associated with the feed item) in a third column, and a feed item body in a fourth column. That is, in some implementations, each row is associated with a particular feed item and the particular feed item is uniquely identified by the respective FeedItemID. The feed item body can include the content to be displayed in or with the feed item when displayed in a network feed. For example, the content in the feed item body can include the text of a publication submitted by the publishing user. The content in the feed item body also can include identifiers, links or addresses to separately stored documents, videos, images or other files or other publications to be displayed with the feed as part of the feed item. For example, in some implementations, the links to the files are displayed in the first hierarchical level of the feed item or a second hierarchical level of the feed item. In some other implementations, the files themselves (or a preview of the files) are displayed as part of the feed item.

In some implementations, other columns can include UserIDs, GroupIDs or RecordIDs of associated users, groups and records that have been @-mentioned by the publishing user as part of the publication. In some implementations, a ParentID can be specified in another column. The ParentID can include, for example, the UserID, RecordID or Group ID corresponding to the user feed, record feed or group feed where the publication was submitted. Another column can include a timestamp associated with a time the publication was submitted. Other columns can include text or links associated with feed-tracked updates to the feed item. Other columns can include the UserIDs of users that have “liked” the post, file or other publication in the feed item. Other columns can include the UserIDs of users that have shared the publication in the feed item.

Other columns of the Feed Items Table can include CommentIDs identifying comments submitted on the publication and to be subsequently included in, for example, a second hierarchical level within the associated feed item when displayed in a network feed. In some such implementations, the database system 16 includes a “Comment Items object.” The Comment Items object is a data structure that can be represented or conceptualized as a “Comment Items Table” that associates comments to associated feed items to which the comments were submitted (or “published”). In some implementations, the Comment Items Table includes all of the comments made by users within the organization. In some other implementations, there can be a Comment Items Table for each division, department, team or other sub-organization within an organization. In implementations in which the organization is a tenant of a multi-tenant enterprise social network platform, the Comment Items Table can include all of the comments within all of the organizations that are tenants of the multitenant enterprise social network platform.

In some such implementations, each row of the Comment Items Table represents a defined relationship or link between a particular comment and an associated feed item to which the comment was published. Each row can include an OrgID in a first column, a CommentID in a second column, a FeedItemID in a third column, a UserID of the publishing user that submitted the comment in a fourth column, and a Comment body in a fourth column. That is, in some implementations, each row is associated with a particular comment and the particular comment is uniquely identified by the respective CommentID. The comment item body can include the content to be displayed in or with the feed item when displayed in a network feed. For example, the content in the comment item body can include the text of a comment submitted by a publishing user. The content in the feed item body also can include links or addresses to separately stored files to be included in the comment when displayed in a network feed. For example, in some implementations, the links to the files are displayed in the comment, while in some other implementations, the files themselves (or a preview of the files) are displayed as part of the comment. In some implementations, other columns can include UserIDs, GroupIDs or RecordIDs of associated users, groups and records that have been @-mentioned by the published user in the comment.

Enterprise social network news feeds are different from typical consumer-facing social network news feeds (for example, FACEBOOK®) in many ways, including in the way they prioritize information. In consumer-facing social networks, the focus is generally on helping the social network users find information that they are personally interested in. But in enterprise social networks, it can, in some instances, applications, or implementations, be desirable from an enterprise's perspective to only distribute relevant enterprise-related information to users and to limit the distribution of irrelevant information. In some implementations, relevant enterprise-related information refers to information that would be predicted or expected to benefit the enterprise by virtue of the recipients knowing the information, such as an update to a database record maintained by or on behalf of the enterprise. Thus, the meaning of relevance differs significantly in the context of a consumer-facing social network as compared with an employee-facing or organization member-facing enterprise social network.

In some implementations, when data such as posts or comments from one or more enterprise users are submitted to a network feed for a particular user, group, record or other object within an online enterprise social network, an email notification or other type of network communication may be transmitted to all users following the respective user, group, record or object in addition to the inclusion of the data as a feed item in one or more user, group, record or other feeds. In some online enterprise social networks, the occurrence of such a notification is limited to the first instance of a published input, which may form part of a larger conversation. For instance, a notification may be transmitted for an initial post, but not for comments on the post. In some other implementations, a separate notification is transmitted for each such publication, such as a comment on a post.

IV. Recommendation Platform

Various implementations relate generally to a recommendation platform, and more specifically, to a recommendation platform for providing customized recommendations to users. Some implementations more particularly relate to a recommendation platform that enables authorized third party users to create, customize and add new recommendations that are then available to be served to target users or audiences of users. Some implementations further relate to a recommendation platform that enables authorized users to define audiences, scheduling settings, scheduling policies, and rules to customize or influence the provision of associated recommendations to the users. The recommendation platform generally includes a recommendation engine that serves the recommendations to users based on such defined audiences, scheduling settings, policies or other rules.

In some implementations, the recommendation platform is hosted by a single- or multi-tenant database system such as the database system 16 described with reference to FIGS. 1A and 1B. As described above, in some implementations the database system 16 includes application servers 100₁-100_{N} that can implement or host one or more applications or platforms for providing various on-demand or cloud-computing features or services described herein. In some implementations, one or more of the application servers 100₁-100_{N} implement or host the recommendation platform. In some implementations, the recommendation platform enables each tenant organization of the database system 16 to create, customize and add new recommendations that are then available to be served to target users or audiences of users both within and external to the organization, including to users affiliated with other tenant organizations.

In some implementations, third party users (or “third parties”) can generally be defined as users, organizations or other entities other than those that own, operate or run the database system 16 or the recommendation platform. In some implementations, the third parties can include administrators or developers within tenant organizations of the database system 16, as well as other external third party developers or independent software vendors (ISVs) that are not tenants of the database system 16 (also referred to herein collectively as “authorized users”). The target users, that is, the users receiving the recommendations, can be users internal to an organization (for example, employees or other authenticated users within the organization), users external to but having relationships with the organization (for example, partners, community members, customers, buyers, or suppliers that may be authenticated by the organization or the database system) as well as other external users (for example, customers, prospective customers, or members of the general public that may or may not be authenticated).

Generally, the recommendation platform can provide recommendations for virtually anything that an entity (such as an organization) may desire to recommend to the target users. In a social networking context, the recommendation platform can enable authorized third parties to customize recommendations to be served to users suggesting other users the users may be interested in following, records the users may be interested in following, groups the users may be interested in subscribing to, or communities the users may be interesting in joining Additionally or alternatively, the recommendation platform can enable authorized third parties to customize recommendations for use in e-commerce applications, for example, recommendations suggesting products or services the users may be interested in learning about or purchasing. For example, such products or services can include various platform as a service (PaaS) platforms, software as a service (SaaS) applications, or other applications or services provided by the database system 16 or provided by third parties. Additionally or alternatively, the recommended products can include tangible products provided by sellers of goods. Additionally or alternatively, the recommendation platform can enable authorized third parties to customize recommendations for use in educational, team-building or network contexts, for example, recommendations for events such as conferences, classes, seminars, webinars or activities the users may be interested in joining, attending or otherwise participating in.

Generally, the recommendation platform can enable authorized users to customize the generation, triggering and provision of recommendations based on virtually any action that occurs within or with respect to the database system. Such actions can include user-initiated actions (or “user actions”) such as the reception of a user input, for example, a user's clicking or other selection of a user interface (UI) element or a user's entering of text or other data into a data field. A recommendation also can be triggered by the act of a user logging into the database system 16 or in response to the authentication of the user by the database system. The actions also can be system actions, for example, the elapsing of a duration of time or the reaching of a particular date or time.

The recommendation platform also can enable authorized users to customize how, where and when the recommendations are displayed or otherwise provided. Generally, the recommendations can be provided to the users via a variety of means; for example, as such users are visiting various websites, webpages, web applications or other web interfaces accessible to the users. In some implementations, the recommendations can be provided as feed items in a social networking feed. In some implementations, recommendations can be displayed in a dedicated recommendations section of a web interface (for example, the recommendations section 520 of the user interface 500 described above with reference to FIG. 5). Additionally or alternatively, the recommendations can be provided in emails, text (for example, SMS) messages, multimedia (for example, MMS) messages, social networking messages, or via various other messaging applications and channels.

In some implementations, the recommendations can include links (for example, hyperlinks), buttons or other UI elements that enable the user to navigate to the respective recommended users, groups, records, communities, products or events enabling the user to obtain more information about the recommendations.

Additionally, in some implementations, the recommendations can include links, buttons or other UI elements that enable the user to follow, join or subscribe to respective users, groups, records or communities. In e-commerce applications, the product recommendations can include links, buttons or other UI elements that enable the user to purchase, subscribe to, access, try, or otherwise obtain the respective products. In the case of recommended products, the recommendations can include links, buttons or other UI elements that enable the user to purchase, subscribe to, access, try, or otherwise obtain the respective products.

Providing the recommendation engine as part of an overarching recommendation platform, as opposed to providing a recommendation engine as a feature within an existing platform, can enable the recommendation engine to be more powerful, for example, having additional functionality and configurability as well as access to additional data. Generally, a platform includes a number of features, such as applications or services (or specific functionality therein), each of which can be enabled or not enabled (or disabled) for a given user or organization. In the context of a multi-tenant database system, the features enabled for a given tenant organization or other third party can be based on a service agreement between the tenant organization (or third party) and the operator of the database system. For example, the service agreement can dictate or specify which permission sets (or “permissions”) are associated with the organization. In turn, an administrator of the organization can define which permissions are associated with individual users, user types, or classes of users within the organization. In some such implementations, the permissions associated with a user define which features are enabled for a particular user.

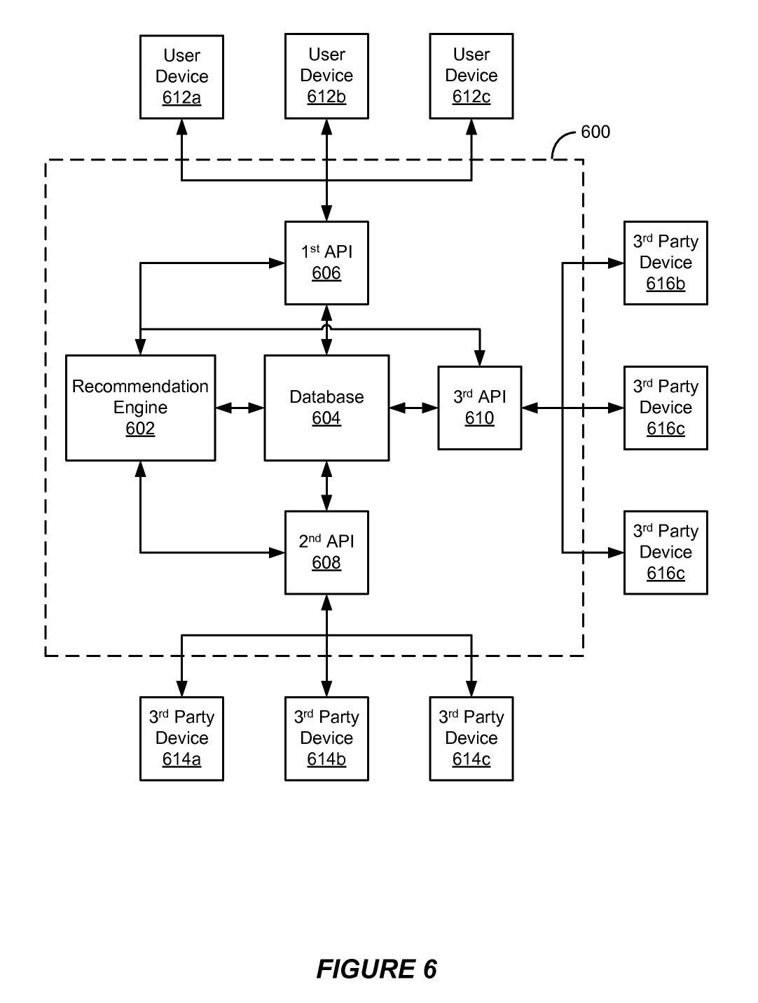

FIG. 6 shows an example recommendation platform 600 according to some implementations. The recommendation platform 600 includes a recommendation engine 602 for serving recommendations to virtually any number of users at virtually any type and number of user computing devices, for example, user devices 612a, 612b and 612c (also referred to herein individually as “a user device 612” or collectively as “user devices 612”). The recommendation platform 600 further includes a database 604 and a number of application programming interfaces (APIs) including a first API (or first set of APIs) 606 and a second API (or second set of APIs) 608. In some implementations, the recommendation platform 600 can additionally include a third API (or third set of APIs) 610. The first API 606 interacts with the user devices 612, and as such, may also be referred to herein as a user-facing API. The second API 608 interacts with authorized users (for example, administrators or developers) at third party devices 614, and as such, may also be referred to herein as an administrator-facing API. The third API 610 interacts with authorized users (for example, developers) at third party devices 616, and as such, may also be referred to herein as a developer-facing API. However, the characterization of the APIs 606, 608 and 610 as user-facing, administrator-facing, or developer-facing is made for simplicity of explanation and should not be read as limiting the functionality of the various APIs or the devices the APIs interact with. Indeed, the user devices 612, the third party devices 614 and the third party devices 616 can be computing devices of the same type in some implementations. Additionally, a single human can be a recipient of a recommendation served via the first API 606 in one context or time, an administrator using the second API 608 in another context or time, or a developer of an application using the third API 610 in another context or time.

Information about the organizations, the users of the organization, as well as users external to the organization can be stored in the database system 16, for example, in the tenant database 22 described above. Various applications or programs, including those offered by the operator of the database system 16, can be stored in the system database 24 as described above. In some implementations, the database system 16 also stores or hosts applications provided by organizations (which may be tenants of a multi-tenant database system 16). In some implementations, the database system 16 also stores or hosts applications provided by other third parties, for example, by third party web developers or ISVs. The database 604 shown and described with reference to FIG. 6 collectively refers to all of those databases, including one or more of those just described, that may be necessary or desirable to implement the following disclosed implementations. In some of the implementations described herein, the database 604 also includes recommendation definitions, audience definitions, schedule definitions, or other rule definitions and associated content or data, as described in more detail below.

As described above, the recommendation platform 600 can include a number of APIs. An API is generally a set of routines, protocols, or tools that enable the construction of applications and that define how the applications communicate or interact with one another. Generally, an API enables an application to communicate with another application through a series of calls, and in the case of some APIs (for example, web APIs), the calls are transmitted over one or more networks. For example, an API may expose (in a limited fashion) some of a first application's internal functions such that application developers can create second applications that make use of the first application's functionality or that share data with the first application. In some implementations, one or more of the APIs described herein are web APIs that define interfaces through which interactions occur between an enterprise and applications that use its assets. For example, depending on the implementation or context, an enterprise can be a tenant organization of the database system 16 or the owner or operator of the database system 16 itself. In some implementations, the applications using the enterprise's assets can be applications provided or hosted by the database system 16, applications provided or hosted by tenant organizations of the database system 16, or applications provided or hosted by third party systems external to the database system 16.

In some implementations, one or more of the APIs described herein enable communication between applications using a web service or combination of web services. For example, a web service can manage the calls between the applications that interact via the API. A web service is generally a collection of technological standards and protocols. For example, a web service interface can be written in Web Services Description Language (WSDL). In some implementations, applications interact with the web service, and more broadly the API, according to a service-oriented architecture (SOA), for example, using Simple Object Access Protocol (SOAP) messages. Such SOAP messages can be conveyed using Hypertext Transfer Protocol (HTTP) request messages and Extensible Markup Language (XML) messages, and in some instances, using JavaScript Object Notation (JSON). In some implementations, the API itself can be coded as a set of HTTP and XML messages. In some other implementations, one or more of the APIs described herein can be implemented according to a resource-oriented architecture (ROA), for example, a representational state transfer (REST)-compliant Web service. REST-compliant web services generally manipulate XML representations of web resources using a set of stateless operations. In some implementations, one or more of the APIs described herein can include a combination of multiple APIs and multiple web services.

In some implementations, an API can allow an application to communicate with another application within the same system (for example, the database system 16). For example, an API can define the permitted interactions of data between an application (for example, the recommendation engine 602) hosted by the database system 16 and another application hosted by the database system 16, for example, a customer relationship management (CRM) application (such as the Salesforce.com SaaS CRM application provided by salesforce.com, inc.) or a social networking application (for example, Chatter®, provided by salesforce.com, inc.). As another example, an API can define the permitted interactions of data between an application (for example, the recommendation engine 602) hosted by the database system 16 and an application developed by a tenant organization of the database system 16 (for example, an add-on application developed by the organization using the Force.com PaaS platform provided by salesforce.com, inc.). In such implementations, the tenant application also can be hosted by the database system 16. In some other implementations, the tenant application can be hosted by a server outside of the database system 16, for example, a server operated by the organization or by another third party system. In some implementations, an API can define the permitted interactions of data between an application (for example, the recommendation engine 602) provided and hosted by the database system 16 and an application developed by a third party web application developer or vendor (for example, such third party applications also can be hosted by the database system 16 or by an external system). In some implementations, an API can define the permitted interactions of data between an application developed or provided by one tenant organization of the database system 16 and an application developed or provided by another tenant organization of the database system (again, the applications developed or provided by the various tenants can be hosted by the database system 16 or by external systems).

As described above, in some implementations, the recommendation platform 600 includes a third API 610 that interacts with authorized third party users at third party devices 616. In some other implementations, the third API 610 can be a part of a different platform provided by the database system 16 (for example, the Force.com platform provided by salesforce.com, inc.). The third API 610 enables authorized third party users to build applications that interact with other applications hosted by the database system 16. In some implementations, the third API 610 also can enable authorized third parties to integrate new features on top of or within the recommendation platform 600 or the recommendation engine 600. For example, the third parties can create entirely new components in which recommendations can be consumed and place those components in their own products, which other users or customers could use to get even more out of recommendations. In some implementations, authorized third parties also can create custom recommendation types and define new signals that can increase the richness or quality of the recommendations served to users.

In some implementations, the first API 606 serves recommendations to users at user devices 612 responsive to triggering events such as the detection of various user actions or system events. As described above, such user actions can include the accessing (or “viewing”) of a web interface for an application, or the selection of a UI element within such a web interface (for example, the selection of a hyperlink, image, or other UI element associated with a user, a record, a group, a community, a product or an event). In some implementations, responsive to certain user actions or other triggering events with respect to an application, the application transmits a call to the first API 606. The first API 606 then transmits a call to the recommendation engine 602. The recommendation engine 602 selects a recommendation, retrieves content for the recommendation from the database 604, and transmits the recommendation to the first API 606 for provision to the user.

The second API 608 interacts with authorized third party users at third party devices 614. In some implementations, the second API 608 broadly enables authorized users to customize how the recommendation engine 602 interacts with various applications to build on the basic, native or innate capabilities, functionalities and processes of the recommendation engine 602. In some implementations, the second API 608 enables authorized users to create and customize declarations to provide the recommendation engine 602 with access to additional data signals (also referred to herein simply as “data”). Such additional data can be from an internal source (for example, proprietary data gathered or owned by the respective organization) or from an external source. The additional data can be input to the recommendation engine 602 via the second API 608 to tailor, customize or otherwise influence the generation, triggering and provision of recommendations by the recommendation engine 602 to various users at user devices 612.

In some implementations, the second API 608 enables administrators or developers within organizations or other third parties to inject custom recommendations into the database 604 for provision to users at user devices 612 via the first API 606. In some implementations, the second API 608 enables the authorized users to add new custom recommendations to the database 604 and to customize, update or delete existing recommendations. In some implementations, the second API 608 also enables authorized users to define what existing recommendations or new custom recommendations are provided to various audiences of users, as well as how, when and where such recommendations are provided.

In some implementations, the second API 608 enables authorized users to declaratively define various recommendation definitions, audience definitions, schedule definitions, and rule definitions, which are then stored as respective data objects in the database 604. The second API 608 also enables the authorized users to edit such definitions as well as to select and link (or “associate”) the definitions to build and provide customized recommendations. The recommendation definitions, audience definitions, schedule definitions, and rule definitions are then accessible to the recommendation engine 602 when determining a list or set of the available recommendations that can be served to a particular audience of users at particular times and in response to particular triggering events. When triggered, the recommendation engine 602 selects an available recommendation from the list of available recommendations to serve to a particular based on one or more of: the particular user device 612 being used by the user, the particular time or date, and the particular triggering event.

In some implementations, the recommendation definitions, audience definitions, schedule definitions, and rule definitions are reusable in the sense that each of the definitions is stored as a data object in the database 604 and available to be associated with other ones of the definitions to customize a current recommendation as well as recommendations in the future. In other words, authorized users can associate any combination of recommendation definitions, audience definitions, schedule definitions or rule definitions (to which they have access) to develop a recommendation strategy. Generally, there can be a many-to-many relationship between the recommendation definitions, audience definitions, schedule definitions and the rule definitions. For example, multiple recommendation definitions can be associated with the same audience definition, the same schedule definition, or the same rule definition. Similarly, multiple audience definitions can be associated with the same recommendation definition, the same schedule definition, or the same rule definition. Similarly, multiple schedule definitions can be associated with the same recommendation definition, the same audience definition, or the same rule definition. Similarly, multiple rule definitions can be associated with the same recommendation definition, the same audience definition, or the same schedule definition. As a further example, a particular recommendation definition can be associated with a first audience definition and a first schedule definition, while the same recommendation definition can simultaneously be associated with a second audience definition and a second schedule definition.

Administrator-Facing API

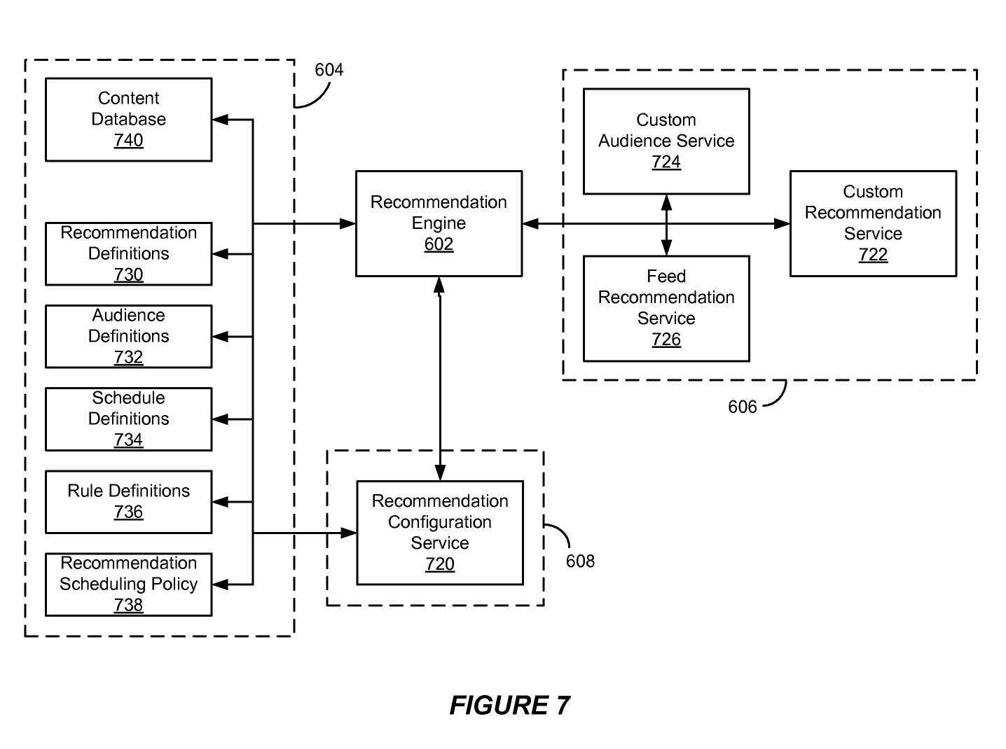

FIG. 7 shows example services provided by the APIs of the recommendation platform 600 of FIG. 6 according to some implementations. The second API 608, also referred to herein as an administrator-facing API, includes a recommendation configuration service 720. FIG. 7 also shows the interaction between the recommendation service 720 and objects within the database 604 in more detail. The database 604 includes recommendation definitions 730, audience definitions 732, schedule definitions 734, rule definitions 736, organization scheduling policies 738, and a recommendation content database 740, each of which can be stored as one or more data objects in the database 604.

In some implementations, the recommendation configuration service 720 enables authorized users to create, edit or delete recommendation definitions 730, audience definitions 732, schedule definitions 734, rule definitions 736, organization scheduling policies 738, and content stored in the recommendation content database 740. For example, the recommendation configuration service 720 is configurable to transmit requests to the database 604 to create, edit or delete the various data objects just described in response to input from authorized users via third party devices 616.

A recommendation definition generally defines the presentation and other attributes of a recommendation. For example, the recommendation configuration service 720 enables an authorized user to create a recommendation definition using a CreateRecommendationDefinition request, update a recommendation definition using an UpdateRecommendationDefinition request, and delete a recommendation definition using a DeleteRecommendationDefinition request. In some implementations, these requests as well as the other request described herein can be XML messages, HTTP requests or other suitable messages. The recommendation configuration service 720 also can retrieve a recommendation definition from the database 604 using a GetRecommendationDefinition request, for example, by specifying a name of the recommendation or a unique recommendation identifier. For example, the GetRecommendationDefinition request enables the authorized user to update and customize an already-created recommendation definition.

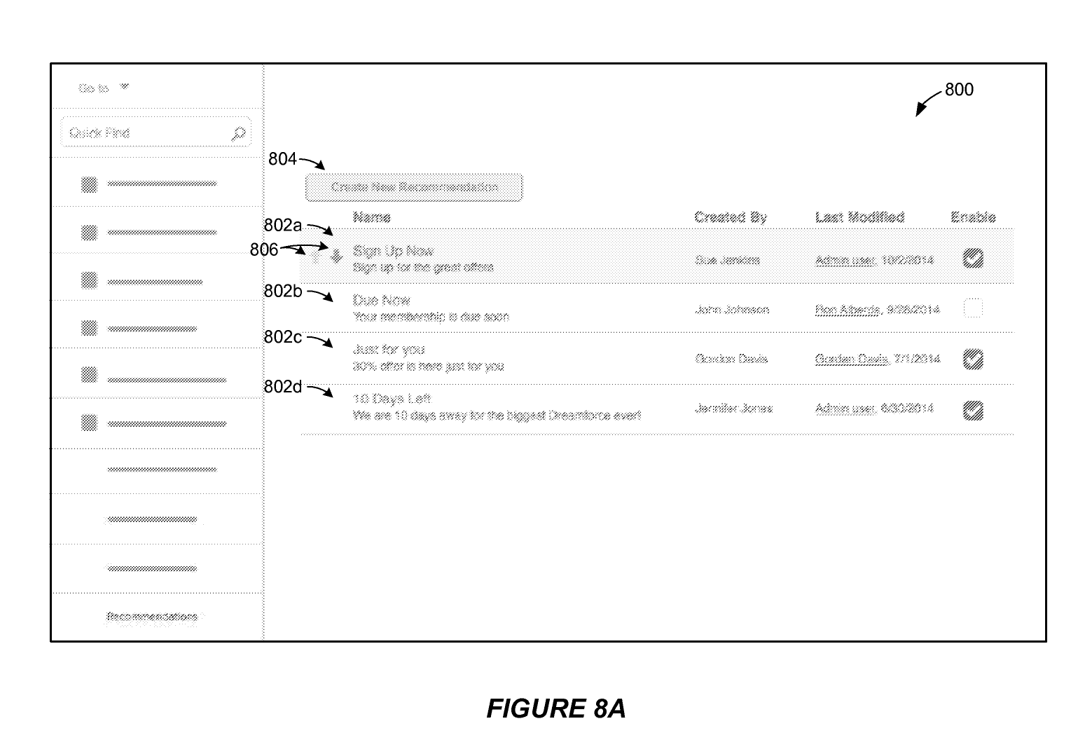

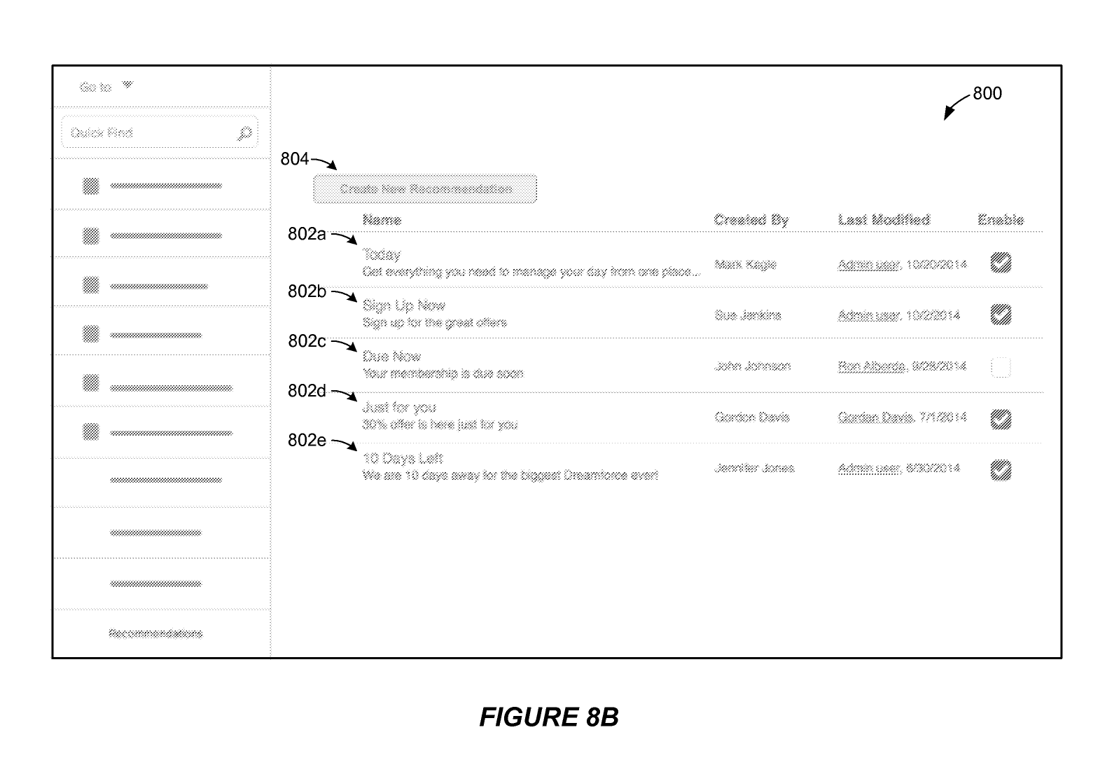

FIG. 8A shows an example of a user interface (UI) 800 for enabling an authorized user to select to create a new recommendation or to select from a list of available existing recommendations according to some implementations. The UI 800 includes existing recommendations 802a, 802b, 802c and 802d. Each of the recommendations 802 is shown with its respective name and a short description (for example, the recommendation 802a is titled “Sign Up Now” and its description reads “Sign up for the great offers”). Each recommendation also includes a name, username, or other identifier indicated who created the recommendation, a date indicating when the recommendation was created or last modified, as well as a checkbox indicating whether the recommendation is enabled (that is, available to be served by the recommendation engine 602). In the illustrated example, the title of each recommendation is a hyperlink that, when selected, navigates the user to an interface showing the attributes for the respective recommendation definition and enabling the user to update the recommendation definition. The UI 800 also includes a button or other selectable UI element 804 that enables the user to create a new recommendation. For example, when the UI element 804 is selected, the user is navigated to a blank recommendation definition template in which the user can define the attributes for the new recommendation. In some implementations, the authorized user also can reorder the recommendations 802 using up and down arrows 806 displayed adjacent the recommendations when the user hovers over or otherwise interacts with the respective recommendation. In some implementations, the recommendations 802 are listed by way of decreasing priority from the top of the list down. In some other implementations, each of the recommendations 802 can include an additional field in which the authorized user can specify a priority, for example, an integer value that indicates the priority of the respective recommendation.

When creating or updating a recommendation definition for a recommendation, the authorized user can specify, via one or more fields, the various attributes of the recommendation (also referred to herein as a recommendation “card”). Such attributes can include a name of the recommendation (for example, a human-readable way to reference the recommendation in a custom framework), a title of the recommendation (for example, a title that appears in or with the recommendation when served), a type of the recommendation (for example, the type of the recommendation can dictate the UI layout of the recommendation), a description of the recommendation (for example, a short summary or explanation of the recommendations purpose or content), a resource address where content of the recommendation is stored (for example, a uniform resource locator (URL) for an image stored in the content database 740 to be displayed in the recommendation card), an action associated with the triggering of the recommendation (for example, an ActionLinkDefinition or an ActionLinkGroupDefinition) as well as in some implementations, a priority for the recommendation.

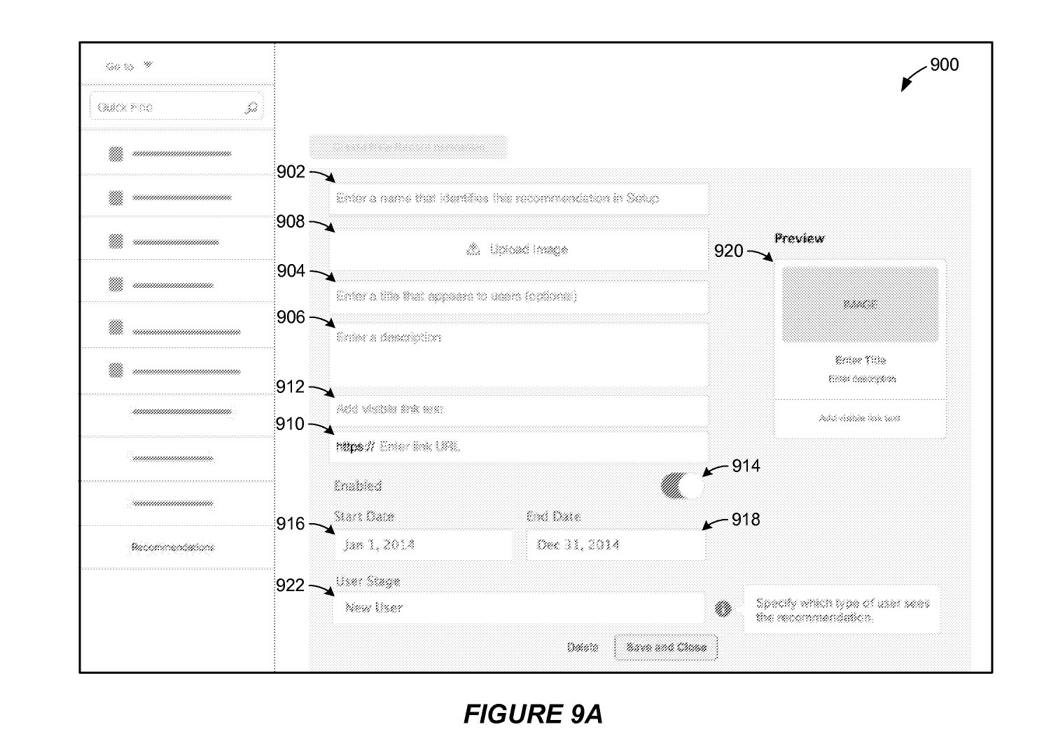

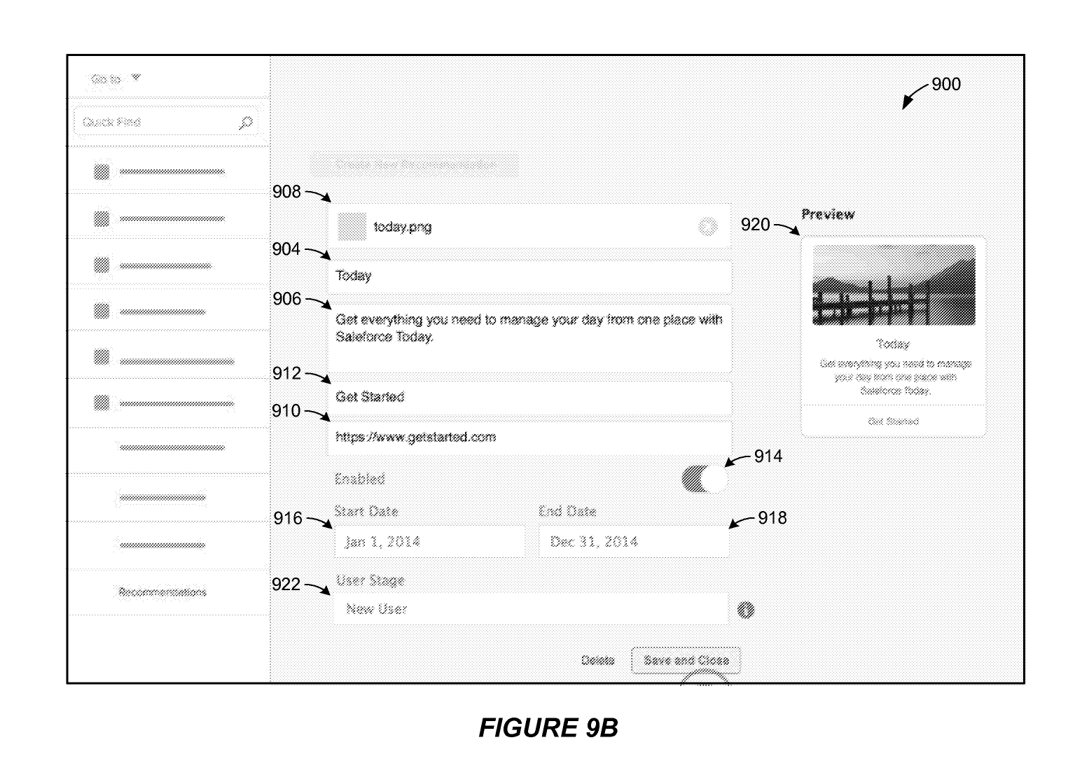

FIG. 9A shows an example of a recommendation definition UI 900 for enabling an authorized user to create or customize a recommendation definition according to some implementations. In some implementations, the recommendation UI 900 can be provided by the recommendation platform 900 to an authorized user at a third party device 614. The recommendation UI 900 enables the authorized user to interact with the third API 610, and more specifically, the recommendation configuration service 720, to declaratively define a recommendation. The UI 900 includes a first field 902 in which the authorized user can enter a name that identifies the recommendation to the authorized user. The UI 900 also includes a second field 904 in which the authorized user can specify a title of the recommendation as it will appear to users receiving the recommendation. The UI 900 also includes a third field 906 in which the authorized user can enter a description of the recommendation.

In some implementations, the UI 900 further includes a fourth field 908 in which the authorized user can specify an image to be displayed when rendering the recommendation served by the recommendation engine 602, for example, by uploading an image file or by selecting an image file already stored in the database 604. For example, the image can be a picture or avatar of another user, an image representing a group, an image representing a record, an image representing a community, an image representing an event or an image representing a product (for example, a picture of a tangible good or a trademark or other descriptive image associated with the product). The UI 900 also can include a fifth field 910 in which the authorized user can enter a link or address (for example, a URL) for a hyperlink displayed with the recommendation. For example, the hyperlink can be selectable to navigate the user to a web page associated with the recommendation such as a user profile page, a record profile page, a group profile page, a community profile page, an event profile page, or a product profile page (for example, where a user can purchase the product or view more information about the product or other products of interest). A sixth field 912 can include text to be displayed as the hyperlink.

In some implementations, the authorized user can specify a second image to be displayed, for example, if the targeted user selects the associated hyperlink or accepts the recommendations (for example, by selecting to follow the recommended user, record, group, or community, by selecting to attend the recommended event, or by purchasing the recommended product). More generally, the image, as well as other presentation details of the recommendation, can change based on a state of the recommendation in the context of the target user to whom the recommendation is served. For example, a first or initial state can be associated with a first image as well as other first presentation details displayed when the recommendation is first served to the user; a second state can be associated with a second image or other second presentation details displayed when the recommendation has been served to the user on more than a specified number of occasions but not selected or accepted by the user; a third state can be associated with a third image or other third presentation details displayed when the recommendation has been selected by the user but not accepted; and a fourth state can be associated with a fourth image or other fourth presentation details displayed when the recommendation has been accepted by the user. In some other implementations, there can be fewer than four or more than four states. For example, there can be only one state and one associated presentation. As another example, there can be two states and two associated presentations: one for a non-selected (or non-accepted) recommendation and one for a selected (or accepted) recommendation. In some such instances, the acceptance of the recommendation can be transmitted asynchronously to the recommendation platform 600, and similarly, the second image or other second presentations details can be transmitted from the recommendation platform to the user device 612 asynchronously such that the new presentation of the recommendation based on the state change is rendered on the display device dynamically and virtually instantaneously. As another example, there can be two or more states and associated presentations for a non-selected recommendation: where each state is associated with a number of occasions on which the recommendation has been served to the user. For example, the presentation of a recommendation may change after a number of servings of the recommendation to a given user in an attempt to engage the user in a different way that may be more appealing to the user.

In some implementations, the recommendation defined by the recommendation definition is not enabled until the authorized user toggles an enable switch 914 or otherwise enables the recommendation. The authorized user also can specify a start date for the recommendation in a field 916 (for example, a date on or after which the recommendation is available to be served), as well as an end date in a field 918 (for example, a date on or after which the recommendation is no longer able to be served). In some implementations, the UI 900 further includes a preview section 920 that displays a preview of the recommendation as it will be rendered and displayed to the user when served to the user's user device 612.

In some implementations, the authorized user also can specify an audience to receive the recommendation in a field 922. For example, the authorized user can specify the audience by a name or title of an associated audience definition, or by another suitable audience identifier. In the illustrated example, the audience is defined by a user stage, and specifically, by the user stage “New User.” Additionally, in some implementations, the UI 900 also can include a field in which the authorized user can assign a priority to the recommendation.

FIG. 9B shows an example of a customized recommendation definition UI 900 after an authorized user has created or customized the recommendation definition using the UI of FIG. 9A. FIG. 8B shows an example of the UI 800 of FIG. 8A after the recommendation definition of FIG. 9B has been added to the database 604.

As described above, an authorized user also can customize an audience of users. An audience definition generally defines a particular audience of users. The recommendation configuration service 720 enables an authorized user to create an audience definition for a particular target audience of users using a CreateRecomendationAudience request, update an audience definition using an UpdateRecommendationAudience request, and delete an audience definition using a DeleteRecommendationAudience. The recommendation configuration service 720 also can retrieve an audience definition from the database 604 using a GetRecommendationAudience request, for example, by specifying a name of the audience or a unique audience identifier. For example, the GetRecommendationAudience request enables the authorized user to update and customize an already-created audience definition.

When creating or updating an audience definition for an audience of users, the authorized user can specify, via one or more fields, the various attributes of the audience. Such attributes can include, for example, one or more OrgIDs, groupIDs, group types, communityIDs, community types (for example, partner community, customer community, supplier community, marketing community), userIDs, user types (for example, user profile types), permission sets, feedIDs, or feed types, among other possible audience identifiers.

As referenced above with respect to FIGS. 9A and 9B, in some implementations, an audience can be defined for each of a plurality of user stages (or “user life cycles”). For example, such user stages can include new users, level 1 users, level 2 users, level 3 users, level 4 users, and so on. In some implementations, the classification of users into levels can be based on the activity of the respective users, for example, as determined by their interactions with other users or with other entities (for example, records, groups or communities). For example, new users can be users who have recently joined an organization. Level 1 users can be users that have not posted to a news feed, commented on a feed item, liked a feed item, shared a feed item or otherwise interacted with a news feed. Continuing the example, users who have posted at least one feed item to a news feed can be upgraded or re-characterized as level 2 users, while users who have posted at least 10 times to one or more news feeds can be upgraded to level 3, and so on. The classification or ranking of users into levels can additionally or alternatively be based on a number of other users, groups or communities the users have respectively followed, subscribed to or joined. Users who have followed, subscribed to or joined a larger number of users, groups or communities can be ranked as higher level users than users who have followed, subscribed to or joined fewer users, groups or communities. In this way, the activity and engagement of users can provide additional data usable by the recommendation engine when determining a list of available recommendations, prioritizing the available recommendations, or selecting among the available recommendations to serve a recommendation to a user. The number of levels can be configured to provide a desired granularity to facilitate the tailoring of recommendations.

For example, when the recommendation engine 602 is triggered to serve a recommendation to a user who is already actively engaged in a social network (for example, by following a large number of users, joining a large number of groups or actively posting to various news feeds), the recommendation engine 602 can prioritize among the set of available recommendations for that user to select a recommendation other than a recommendation to follow a user or to join a group. For example, the recommendation engine 602 can prioritize recommendations for seminars, webinars, other events or activities, products, or other suitable recommendations over recommendations related to users or groups.

Additionally or alternatively, in some implementations, defining audiences by user profile types or permission sets can be useful, for example, in order to ensure that users are served only those recommendations for which they have the permissions to act on. Defining audiences by user profile types or permission sets also can be useful to tailor recommendation to users based on the users' respective roles or responsibilities (as, for example, defined by the sets of permissions associated with the users). In some implementations, data or information about users (including users' respective user profiles) can be arranged in a layered, leveled or hierarchical object structure. For example, a user profile can be considered one level of abstraction in such a layered data object. A user profile includes information about the user (for example, in one or more lower level data objects or fields). In some implementations, each user profile additionally includes a default set of permissions enabled for the user (for example, as a permissions data object). In some implementations, each set of permissions can include one or more user permissions, object permissions, field permissions, class permissions, page permissions, service provider permissions, connected application permissions, application settings, tab settings, record type permissions, or other desired permission settings (all referred to collectively herein simply as “permissions”). In some implementations, one or more additional (or “secondary”) sets of permissions can be layered over a user's profile. In some implementations, because some or all of the permissions can be additive, by adding (or “layering”) one or more additional sets of permissions over a single user profile, the user profile can be associated with virtually any number of sets of permissions in addition to the default set of permissions included in the user profile.

In this way, the permissions included in the user's user profile (for example, the default set of permissions) can remain fixed or unchanged across users associated with a particular standard user profile, while the permissions granted to a particular one of the users at a particular time can be based on, for example, a current, new, temporary, or time-varying role, sub-role (within a larger role), set of duties, task, assignment, responsibility, or a combination of these (also referred to collectively herein as a “role”). Additionally or alternatively, the permissions granted to a particular one of the users at a particular time can be based on the role of the user with respect to a particular stage in a sales process, an investigatory process, a negotiation or contract process, a services process, a support process, or another suitable business or technical process.

In some implementations, the recommendation configuration service 720 also enables authorized users to create rule or event-based definitions. A rule definition can generally define a recommendation-triggering event and a rule that defines what actions to take based on the detection of the event. In some other implementations, such a rule definition can be incorporated into an audience definition or into a schedule definition (described further below). Such triggering events can be, for example, the occurrence of a user clicking on or selecting a hyperlink or other UI element within a webpage associated with the organization, such as a user profile page, a group page, a community page, a record page or another page. Some events can be contextual in nature. For example, an administrator can define a rule that causes the recommendation engine 602 to, in response to a detection that a user has selected to view a profile of a certain type (for example, a manager), displays one or more recommendations for one or more other profiles of that type (for example, other managers). As another example, an authorized user can create a rule definition such that all or a portion of the participants in a social event receive a recommendation associated with the event at a particular time or times prior to the event (in this example, the triggering event is the specified time). For example, an authorized user can customize a rule definition for registrants of a conference that causes the recommendation engine 602 to serve recommendations of hotels to those registrants located outside of a defined geographic area around the conference location one month before the conference. Generally, different recommendations can be served to different audiences during different time periods, at different times within the time periods, and at different frequencies.

In some implementations, rules can define audiences based on actions. For example, a rule can define an audience based on the performance of a particular set of one or more actions within a particular time frame (which may be all time), or the lack of performance of a particular set of one or more actions within a particular time frame. For example, the recommendation engine 602 can generate a list of users subscribed to a first group but who are not subscribed to a second group, and in some user-defined instances, only those users that have visited, posted to or otherwise interacted with the first group's news feed within the last month. The rule can cause the recommendation engine 602 to, in response to a user identified in the list accessing the first group's news feed, include a recommendation to the user to view or subscribe to the second group. For example, the second group can be a new group sharing an overlapping audience, having a similar purpose or directed to a related topic.

In some implementations, the set of actions defined by the rule can themselves be defined by an action type or by a target of the action (for example, the selection of a particular link or UI element, which may itself be associated with a corresponding type or profile, such as when a link is associated with a particular user, group, community, or product). In some implementations, the database system 16 can be configured to generate lists of such users that have or have not performed actions based on the performance rules on a periodic basis (for example, on a daily basis). In such a way, a rule definition can be used to define a target audience periodically (or otherwise dynamically), such as on a daily basis. Additionally, in this way, the target audiences can already be generated and available to the recommendation engine 602 when a user within the target audience is to be served a recommendation.

In some implementations, the recommendation configuration service 720 also enables authorized users to create schedule definitions. A schedule definition generally defines when, where, and how a given recommendation is to be served and presented to a user. The recommendation configuration service 720 can create a schedule definition for a particular user using a ScheduleUserLevelRecommendation request, create an organization wide schedule definition using a ScheduleOrgLevelRecommendation request, update a schedule definition using an UpdateScheduledRecommendation request, or delete a schedule definition using a deleteScheduledRecommendation request. The recommendation configuration service 720 also can retrieve a schedule definition from the database 604 using a GetScheduledRecommendation request, for example, by specifying a name of the schedule or a unique schedule identifier. For example, the GetScheduledRecommendation request enables the authorized user to update and customize an already-created schedule definition.

When creating or updating a schedule definition for a recommendation, the authorized user can specify, via one or more fields, the various schedule settings. Such settings can include for example, an identifier of an associated recommendation definition and an identifier of an associated audience definition. In some implementations, the authorized user also can specify a priority (for example, an integer value) of the associated recommendation relative to other recommendations (rather than defining the priority in the respective recommendation definition). The authorized user also can specify a maximum frequency, for example, defining a maximum frequency (such as serves per hour, serves per day, serves per week, serves per month, or serves over all time) at which the recommendation can be served to a given user, organization, or other entity within the associated audience. Similarly, the authorized user also can specify a base period for the recommendation, for example, defining a time duration that must elapse after the serving of the recommendation before the recommendation can be served to the same target again. In some implementations, an authorized user also can specify a policy type for the recommendation that causes the recommendation engine 602 to adjust the base period over time (for example, the policy can cause the base period to increase with an increase in the number of times the recommendation has been served to the target). The authorized user also can specify a location and endpoint, for example, defining the media (such as a feed item in a news feed, an email, a text, a multimedia message, or a pop-up window or banner) by which the associated recommendation is to be served, as well as a particular position within an interface (such as a user, record, group or community profile page or news feed) in which the recommendation is to be rendered for presentation. In some implementations in which the recommendation is to be served as a feed item in a news feed, the authorized user can specify that the recommendation feed item is only to be displayed to the targeted user, and not in the news feeds displayed to others users who follow the targeted user. The authorized user also can specify a start date, for example, defining a time after which the associated recommendation is available to be served. The authorized user also can specify an end date, for example, defining a time after which the associated recommendation is no longer available to be served.

The authorized user also can define an organization wide or other overarching scheduling policy for serving recommendations. The authorized user also can create or update the scheduling policy by specifying one or more fields, for example, a MinElapsedTimeBetweenRecs (which dictates the minimum time between serving recommendations), a MaxFrequencySingleRec (which dictates the maximum frequency for serving any one recommendation), a MaxFrequencyTotalRecsPerDay (which dictates the maximum frequency at which recommendations are collectively served), and a ReclnFeedDensityThreshold (which dictates the maximum number of recommendations in the form of feed items that can be shown in a feed based on the number of other non-recommendation feed items).

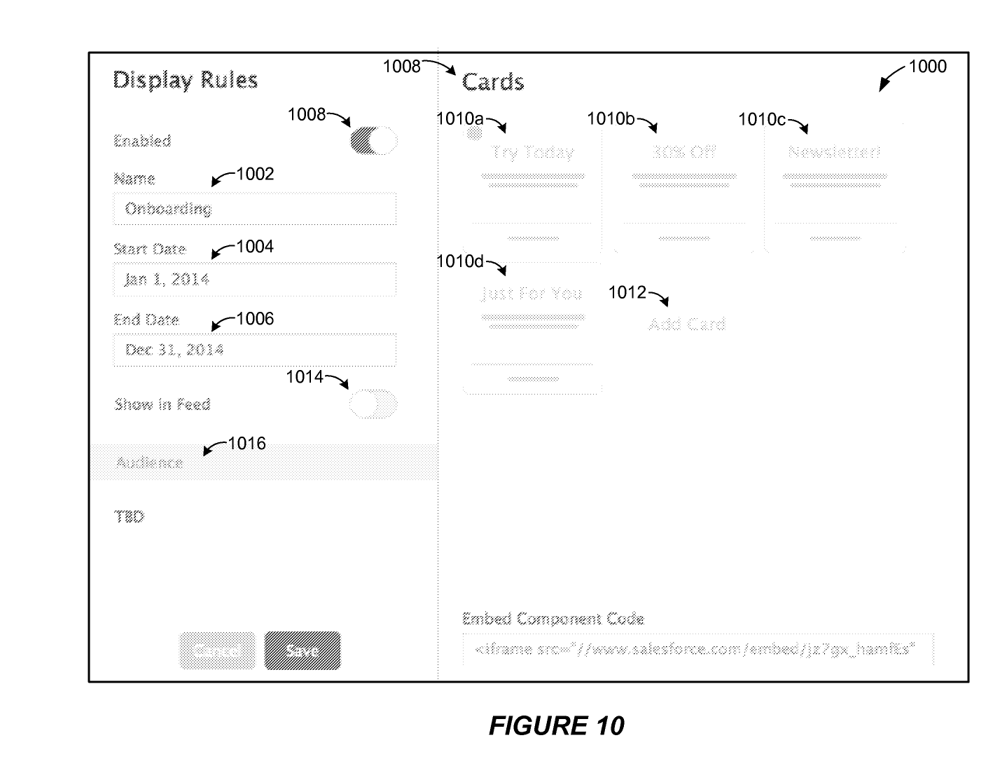

FIG. 10 shows an example of a UI 1000 for enabling an authorized user to create or customize a rule definition according to some implementations. The UI 1000 includes a first field 1002 enabling the authorized user to enter a name for the rule, a second field 1004 enabling the authorized user to enter a start date for the rule, and a third field 1006 enabling the authorized user to enter an end date for the rule. The UI 1000 includes a “Cards” section 1008 showing recommendations (“cards”) associated with the rule. In the illustrated example, the associated cards include a first card 1010a for a recommendation titled “Try Today,” a second card 1010b for a recommendation titled “30% Off,” a third card 1010c for a recommendation titled “Newsletter,” and a fourth card 1010d for a recommendation titled “Just for You.” The cards section and a fifth card 1010e for a recommendation titled “Try Today.” The UI 1000 also enables the authorized user to add or delete recommendations. For example, the cards section 1008 also includes a blank card 1012 titled “Add Card” that enables the authorized user to add a card for a recommendation to be associated with the rule. The UI 1000 also can include an enable toggle switch or other UI element 1014 that enables the authorized user to specify whether the associated cards 1010 can be served in a social networking feed. The UI 1000 also includes an audience section 1016 enabling the authorized user to associated audiences with the rule definition.

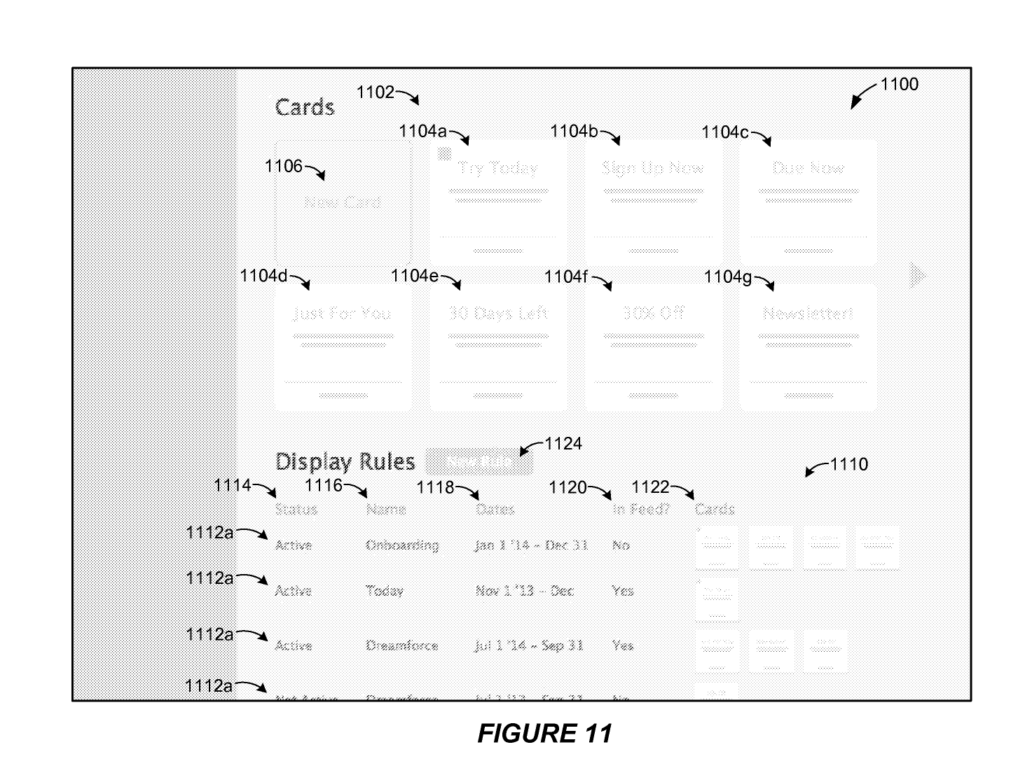

FIG. 11 shows an example of a UI 1100 for enabling an authorized user to associate recommendation definitions and rule definitions according to some implementations. The UI 1100 includes a “Cards” section 1102 showing various recommendation cards 1104. In the illustrated example, the available cards include a first card 1104a for a recommendation titled “Try Today,” a second card 1104b for a recommendation titled “Sign Up Now,” a third card 1104c for a recommendation titled “Due Now,” a fourth card 1104d for a recommendation titled “Just For You,” a fifth card 1104e for a recommendation titled “30 Days Left,” a sixth card 1104f for a recommendation titled “30% Off,” and a seventh card 1104g for a recommendation titled “Newsletter.” The UI 1100 also enables the authorized user to add or delete recommendation cards. For example, the cards section 1102 also includes a blank card 1106 titled “New Card” that enables the authorized user to create a new recommendation card.

The UI 1100 also includes a “Rules” section 1110 showing various rules 1112a, 1112b, 1112c and 1112d. In the illustrated example, the rules section 1110 includes a “Status” column 1114 indicating a status of each of the rules 1112, a “Name” column 1116 indicating a name of each of the rules 1112, a “Dates” column 1118 indicating a duration of time during which the rule is applied or to be applied, an “In Feed?” column 1120 indicating whether the recommendation cards associated with the rule are permitted to be served in a feed, and a “Cards” column 1122 that shows the recommendation cards associated with the rule. The UI 1100 also enables the authorized user to add or delete rules. For example, the authorized user can select a “New Rule” button 1124 to create a new rule definition for a new rule. The UI 1100 enables the authorized user to associate the recommendation cards 1104 in the cards section 1102 with respective rules 1112 in the rules section 1110. For example, in some implementations, the authorized user can “drag and drop” cards from the cards section 1102 to the Cards column 1122 to associate the cards with the respective rules.

User-Facing API

Referring back to FIG. 7, the first API 606 includes a custom recommendation service 722, a custom audience service 724 and a feed recommendation service 726. The custom recommendation service 722 enables the retrieval of recommendations, for example, using a GetRecommendation request. The custom recommendation service 722 uses, or works in conjunction with, the custom audience service 724 to determine the output of the GetRecommendation request. For example, the custom recommendation service 722 also can utilize the GetRecommendationDefinition, GetRecommendationAudience, and GetScheduledRecommendation requests described above. The custom audience service 724 functions to determine which audiences a given user belongs to, for example, using a GetRecommendationAudience request based on the user's unique User ID. In some implementations, the custom recommendation service 724 can work in conjunction with the feed recommendation service 726 to serve a recommendation as a feed item in a feed.

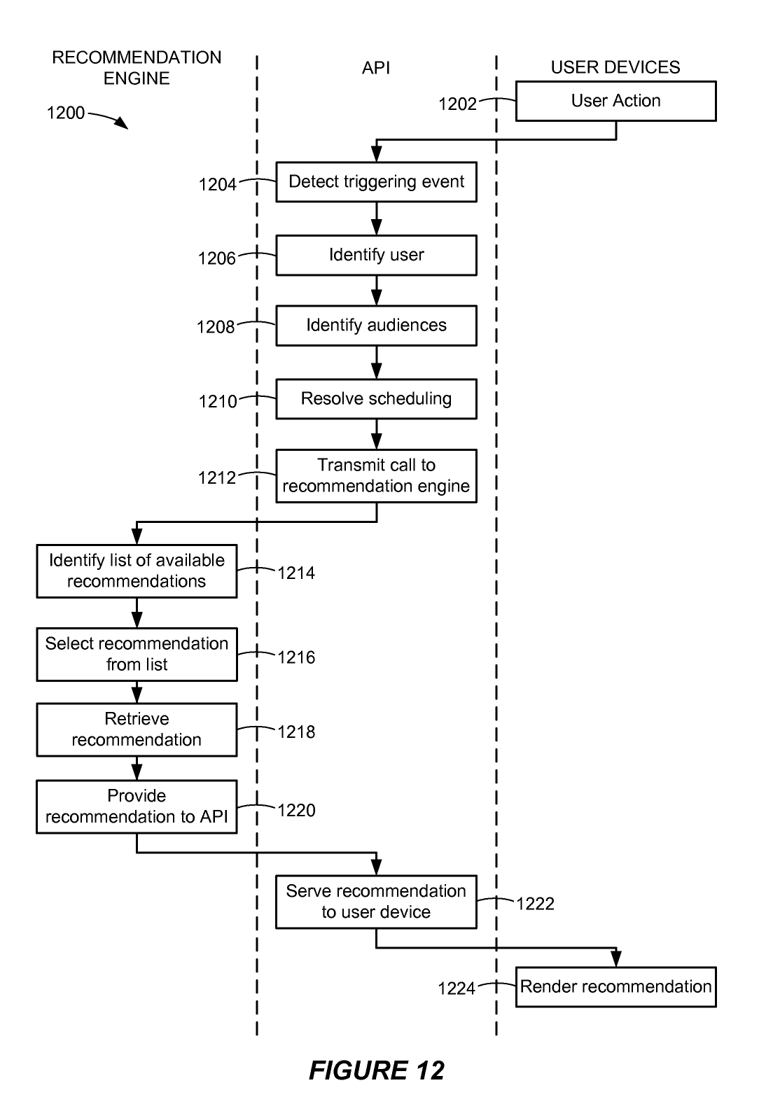

FIG. 12 shows a flow chart illustrating an example of a process 1200 for serving a recommendation to a user according to some implementations. In some implementations, the process 1200 begins in block 1202 when a user performs some user action, for example, by clicking or selecting a UI element, entering text, or simply logging into the database system 16. In block 1204, the API 606 (for example, the custom recommendation service 722) detects a triggering event based on the user action, and in block 1206, identifies the user associated with the triggering event. The API 606 (for example, the custom audience service 724) then identifies the audiences to which the user belongs in block 1208. In block 1210, the API 606 (for example, the custom recommendation service 722) resolves any scheduling issues and otherwise ensures that the scheduling settings and policies are identified and complied with. The API 606 (for example, the custom recommendation service 722) then transmits a call (for example, a GetRecommendation request) to the recommendation engine in block 1212 requesting a recommendation based on the identified audiences and the scheduling.

In block 1214, the recommendation engine 602 generates or identifies a list of available recommendations based at least in part on the identified audiences and the scheduling. In block 1216, the recommendation engine 602 selects at least one recommendation to serve to the user from the list of available recommendations. The recommendation engine 602 then retrieves the recommendation (for example, by retrieving content from the content database 740). The recommendation engine 602 then provides the recommendation to the API 606 in block 1220. The API 606 then serves the recommendation to the user device in block 1222 (for example, the feed recommendation service 726 can serve the recommendation in a feed), where it is then rendered for display in block 1224. In some implementations, the act of a user selecting or accepting the recommendation rendered in block 1224 can cause a state change to the recommendation in the context of the particular user. For example, in response to the targeted user accepting the recommendation, a state of the recommendation in the context of the user can be changed, and additionally, the recommendation can be removed from the list of available recommendations that can be served to the same user in the future.

In some implementations, the user action in block 1202 can be an action to access a feed, for example, by selecting to navigate to the feed or by navigating to a profile page that includes the feed. In some implementations, in response, a request can be transmitted from the user device to the feed recommendation service 726. The reception of the request can be the triggering event in block 1204. In some implementations, the feed recommendation service 726 subsequently calls the custom recommendation service 722. The custom recommendation service 722 determines which recommendations are available to the user. In some implementations, this determination can include two general steps. In the first step, the custom recommendation service 722 calls the custom audience service 724. The custom audience service 724 determines which audiences the identified user belongs to. In the second step, the custom recommendation service 722 then transmits a call to the recommendation engine 602 to obtain a recommendation based on the identified audiences. For example, the call transmitted by the custom recommendation service 722 to the recommendation engine 602 can include a GetRecommendation request. The recommendation engine 602 generates or identifies the list of available recommendations based on the identified audiences and the associated schedule definitions and policies.

As described above, in some implementations, the described recommendation definitions, audience definitions, rule definitions, schedule definitions and scheduling policies determine which recommendations are available to be served to particulars at particular times. However, in some implementations, while an authorized user can customize which recommendations are available to be served to a target audience based on particular scheduling settings, policies or rules, it is the recommendation engine 602 that selects among the available recommendations. In some implementations, a set or list of recommendations available to be served to a user is generated on a periodic basis (for example, a daily basis). For example, blocks 1206, 1208 and 1210 can be performed on a daily basis as opposed to being performed in response to the detection of a triggering event. In this way, the set of available recommendations can already be generated and available to the recommendation engine 602 when the recommendation engine 602 is called to select and serve a recommendation to a user (for example, in blocks 1214 and 1216 of the process 1200).

Generally, the recommendation engine 602 can select among the list of available recommendations to serve to a user based on data associated with the user, past experiences of the user and of other users who have been served with the recommendations. In this way, the recommendation engine 602 can select among the most relevant or interesting recommendations from which to serve the user. Such intelligent selection can result in the serving of recommendations that the user will be more likely to find interesting and to engage with. In some implementations, the recommendation engine 602 can select a recommendation from among the available set of recommendations to serve to a particular user based on one or more of: common connections between the user and other users; a management hierarchy; on tracked activities or determined interests of the user; on activities, interests, or events associated with other users, groups, records or communities the user follows; on priorities customized by authorized users, or based on knowledge of the success of particular recommendations (for example, based on products the user has purchased in the past or products that other users with similar interests as the user have purchased).

For example, in a social networking context, the recommendation engine 602 can recommend the following of: other users that follow the same users as the user to whom the recommendation is provided, other users that are in the same management hierarchy (such as the user's manager, other users that report to the user's manager, or other users that report to the user), other users that are generally popular (for example, users that have many followers), other users that are new to the organization or new to the social networking system, other users that are interested in the same records as the user (for example, other users that have looked at or edited a record that the user owns, has viewed or has edited), or other users that are often followed together with users the user already follows (for example, if the user follows Madison Rigsby, the recommendation engine can generate and provide a recommendation to follow Suzanne Powell if many users who follow Madison also follow Suzanne). In the context of group recommendations, the recommendation engine 602 can recommend the following of a group to a user based on the popularity of the group as determined by the number and identities of the other users following the group, based on the number of other users in the group that the user follows, or based on the date the group was created (for example, the recommendation engine can be more likely to recommend a newly created group than an older group).

In the context of product recommendations, the recommendation engine 602 can select product recommendations for a user based on other products the user or the user's organization uses, purchases or subscribes to, as well as based on analytics derived or generated for the user or the user's organization based on past, current or predicted future needs or experiences of the users or their respective organizations. For example, the recommendation engine 602 can select product recommendations to serve to a particular target user based on products the user has purchased in the past (for example, products previously recommended and accepted/purchased by the user), viewed in the past, or products that other users with similar interests, roles, positions or other characteristics as the user have purchased. As described above, such a product recommendation can be included as a feed item in a news feed. Including such a product recommendation can be advantageous for a number of reasons including, for example, to provide a user with recommendations to try or buy a new product, to use and enable new functionality in an existing product the user uses, as well as to ensure that the user (for example, a newer user) does not have an empty feed. To ensure that the user to whom the product recommendation is to be served has access to (or the right to use) the product, the recommendation engine 602 or the API 606 can analyze the permissions associated with the user (as described above). For example, one or more of the custom recommendation service 722, the custom audience service 724, the feed recommendation service 726 can transmit one or more calls to an internal security (or permission) service within the database system 16 (not shown) to verify that the feature or function is permitted for the user, determine whether the feature is enabled for provision to a feed, or more generally determine whether the recommendation is available to be served to the user (for example, based on the schedule definition or scheduling policy associated with the recommendation and organization). In some implementations, such an internal security or permission service can be utilized prior to serving any recommendation to any user to ensure that the recommendation is appropriate based on the permissions assigned or granted to the user.

Knowledge of the likelihoods of engagement with recommendations also can be used by the recommendation engine 602 to select recommendations that are likely to be relevant or interesting to new users to facilitate the engagement of the new users and the integration of the users into the social network of users and more broadly into the social graph of users and data. More generally, the recommendation engine 602 can select recommendations to serve to particular users based on the respective lengths of time the users have been users of the database system (for example, as described with reference to the user stages or user life cycles described above). Additionally or alternatively, the recommendation engine can select a recommendation to serve to a user based on the a level of involvement or activity demonstrated by the user with respect to the database system (for example, based on engagement or interactions with other users, groups, communities, records or products). In this way, the recommendation engine can select the best recommendation to serve to a particular user at a particular time.

Thus, the available set of recommendations determined for a user can be based on the audiences the users is a part of and based on an action that triggered the serving of the recommendation, while the user's user stage and tracked activities or interests of the user can be a criteria used by the recommendation engine 602 to select a recommendation from the list of available recommendations.

In some implementations, when the recommendation engine 602 serves a recommendation from the list of available recommendations, the recommendation engine 602 also reorders the list of available recommendations such the last-served recommendation is moved to the bottom or lowest level of priority in the priority list and the second highest priority level recommendation becomes the new highest priority level recommendation. In other words, the recommendation engine 602 cycles through the list of available recommendations. In some implementations, the list of available recommendations is reordered at the target audience level. That is, when a first member of the target audience is served the topmost or highest priority level recommendation from the list of available recommendations, then the next time a member of the target audience (whether the first member or a different member) is served a recommendation from the same list, the recommendation that is served is the new highest level priority recommendation. In some other implementations, the list of available recommendations is reordered at the user level. That is, each list of available recommendations can be generated or associated with a corresponding user such that the serving of a recommendation to a first member of the target audience does not affect the priority of recommendations for a second member of the target audience.

In some implementations, the recommendation engine 602 can reorder or reprioritize a list of available recommendations based on a more intelligent strategy. For example, each recommendation in the list of available recommendations can be associated with a particular serving frequency that influences the probability that the recommendation is served (for example, as described with reference to the schedule definitions described above). For example, recommendations associated with higher serving frequencies have a greater probability of being selected by the recommendation engine 602 for service than recommendation associated with lower serving frequency. In some such implementations, the recommendation engine 602 is configured to calculate or otherwise determine the serving frequency for each recommendation in a list of available recommendations dynamically based on users' interactions with the recommendations that they are served.

In some implementations, the act of clicking on or selecting a recommendation or another action that otherwise expresses or indicates an interest in a recommendation (for example, a like) can be used as an input to the recommendation engine. For example, if the recommendation engine 602 receives a significant or threshold amount of interest in a particular recommendation, the recommendation engine 602 can reprioritize the recommendation, for example, by reordering the recommendation to a higher level in a priority list of recommendations or by increasing the serving frequency associated with the recommendation. Conversely, if the recommendation engine 602 receives little or no interest in a particular recommendation, the recommendation engine 602 can reorder the recommendation to a lower level in a priority list of recommendations, decrease the serving frequency associated with the recommendation or even stop serving the recommendation (for example, by removing the recommendation from the list of available recommendations). In some implementations, the act of a user selecting a recommendation can be used as one criteria to score the interest level in (or “success level of”) a recommendation. In some such implementations, the act of subsequently choosing to follow a recommended user, subscribe to a recommended group, join a recommended community, like a recommended page, or like or purchase a recommended product can be used as a second criteria to score the recommendation. In some implementations, when a user accepts a recommendation, that recommendation is removed from the set of available recommendations that can be served to the user.

In some implementations, the recommendation engine 602 recalculates or re-determines a serving frequency of the recommendation based on such scores. In some implementations, the serving frequency determined for a recommendation can be applied to a list of available recommendations for a particular user, a particular audience of users, throughout a particular organization or even across organizations or to external users such as external users in communities or in the general public. In some implementations, the serving frequency for a particular recommendation can be updated across all users, but determined differently for different users, audiences of users, or organizations based on other factors.

In some implementations, administrators also can run “dark launches” or A/B tests and other types of experiments that show how well the recommendations would work in production before turning them on for all users. In some implementations, the recommendation platform 600 also can be customized to generate various reports and metrics for the recommendations. For example, administrators also can have access to dashboards and analytics that show how well their recommendations are working for various audiences, user types, or organizations, or across all organizations, and determine what adjustments, if any, they might want to make to ensure the recommendations have the best chance of success. In some implementations, administrators also can see, for each recommendation setting, how that setting is likely to affect adoption and engagement on their organization.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects. Additionally, while the disclosed examples are often described herein with reference to an implementation in which an on-demand database service environment is implemented in a system having an application server providing a front end for an on-demand database service capable of supporting multiple tenants, the present implementations are not limited to multi-tenant databases or deployment on application servers. Implementations may be practiced using other database architectures, i.e., ORACLE®, DB2® by IBM and the like without departing from the scope of the implementations claimed.

It should also be understood that some of the disclosed implementations can be embodied in the form of various types of hardware, software, firmware, or combinations thereof, including in the form of control logic, and using such hardware or software in a modular or integrated manner. Other ways or methods are possible using hardware and a combination of hardware and software. Additionally, any of the software components or functions described in this application can be implemented as software code to be executed by one or more processors using any suitable computer language such as, for example, Java, C++ or Perl using, for example, existing or object-oriented techniques. The software code can be stored as a computer- or processor-executable instructions or commands on a physical non-transitory computer-readable medium. Examples of suitable media include random access memory (RAM), read only memory (ROM), magnetic media such as a hard-drive or a floppy disk, or an optical medium such as a compact disk (CD) or DVD (digital versatile disk), flash memory, and the like, or any combination of such storage or transmission devices. Computer-readable media encoded with the software/program code may be packaged with a compatible device or provided separately from other devices (for example, via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While some implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A database system configurable to:
maintain a database configurable to store:
organization data for a plurality of organizations that are tenants of the database system;
a plurality of recommendation definitions, each recommendation definition defining a respective recommendation; and
a plurality of audience definitions, each audience definition defining an audience of users;
host a recommendation engine configurable to serve recommendations based on the recommendation definitions and the audience definitions; and
host at least one application programming interface (API) defining interactions between the recommendation engine and the database, the API configurable to enable an authorized third party user to:
create a recommendation definition or edit an existing recommendation definition in the database;
create an audience definition or edit an existing audience definition in the database; and
associate a recommendation definition with an audience definition.

2. The database system of claim 1, wherein:
the API is configurable to:
determine that a recommendation is to be served to a user, and
identify one or more audience definitions that include the user; and
the recommendation engine is configurable to:
identify one or more recommendation definitions associated with the identified audience definitions,
select a recommendation definition from the identified recommendation definitions; and
the API is further configurable to:
serve the respective recommendation to the user based on the selected recommendation definition.

3. The database system of claim 2, wherein recommendation engine is configurable to:
prioritize the recommendation definitions in the identified recommendation definitions; and
select the recommendation definition having the highest priority.

4. The database system of claim 3, wherein the recommendation engine is configurable to prioritize the recommendation definitions based on one or more associated audience definitions.

5. The database system of claim 3, wherein the recommendation engine is configurable to prioritize the recommendation definitions based on one or more associated scheduling policies.

6. The database system of claim 3, wherein the recommendation engine is configurable to prioritize the recommendation definitions for the user based a determined level of engagement of the user with a social network.

7. The database system of claim 3, wherein the recommendation engine is configurable to prioritize the recommendation definitions based on historical data collected on previous servings of recommendations associated with one or more of the identified recommendation definitions.

8. The database system of claim 1, wherein the authorized third party user is an administrator of one of the organizations.

9. The database system of claim 1, wherein the API is configurable to enable the authorized third party user to associate a recommendation definition with multiple audience definitions.

10. The database system of claim 1, wherein the API is configurable to enable the authorized third party user to associate an audience definition with multiple recommendation definitions.

11. The database system of claim 1, wherein each recommendation definition includes one or more of: a title of the recommendation, a type of the recommendation, a description of the recommendation, content of the recommendation, an identifier of a location where content of the recommendation is accessible, and an action associated with the recommendation.

12. The database system of claim 1, wherein each audience definition includes one or more of: one or more user types, one or more user profile types, one or more sets of one or more permissions, one or more group types, one or more community types.

13. The database system of claim 1, wherein:
the database further stores a plurality of schedule definitions, each schedule definition defining one or more serving parameters for serving an associated recommendation; and
the API is configurable to enable the authorized user to create a schedule definition or edit an existing schedule definition, and associate a schedule definition with one or more recommendation definitions.

14. The database system of claim 13, wherein the API is configurable to enable the authorized user to associate a schedule definition with one or more audience definitions, the schedule definition further defining which serving parameters are associated with each of the audience definitions.

15. The database system of claim 13, wherein the one or more serving parameters include one or more of: a start date indicating a time after which the associated recommendation is permitted to be served by the recommendation engine; an end date indicating a time after which the associated recommendation is no longer permitted to be served by the recommendation engine; a serving frequency indicating a frequency at which the associated recommendation is to be served; a maximum frequency indicating a maximum frequency at which the associated recommendation is to be served; a maximum number indicating a maximum number of times the associated recommendation is to be served; a time of day at or during which the associated recommendation is to be served; and a day of the week during which the associated recommendation is to be served.

16. The database system of claim 1, wherein:
the database further stores a plurality of rule definitions, each rule definition defining one or more rules for serving an associated recommendation; and
the API is configurable to enable the authorized user to create a rule definition or edit an existing rule definition, and associate a rule definition with one or more recommendation definitions or one or more audience definitions.

17. The database system of claim 16, wherein each rule definition includes one or more of: a combination of one or more actions that trigger the recommendation engine to serve an associated recommendation; a combination of one or more inactions that trigger the recommendation engine to serve an associated recommendation; and a combination of one or more actions and one or more inactions that trigger the recommendation engine to serve an associated recommendation.

18. The database system of claim 1, wherein the recommendations corresponding to the recommendation definitions can include recommendations for one or more of: another user to follow, a group to subscribe to or a community to join.

19. The database system of claim 1, wherein the recommendations corresponding to the recommendation definitions can include recommendations for an event to attend.

20. The database system of claim 1, wherein the recommendations corresponding to the recommendation definitions can include recommendations for one or more of: a software product to buy or try, a cloud-service-based product to buy or try or a tangible product to buy or try.

21. The database system of claim 1, wherein the database system is configurable to generate one or more reports or performance metrics based on the serving of the recommendations.

22. A database system configurable to:
maintain a database storing:
organization data associated with at least one organization;
a plurality of recommendation definitions, each recommendation definition defining a respective recommendation; and
a plurality of audience definitions, each audience definition defining an audience of users; and
host a recommendation engine and at least one application programming interface (API) configurable to interact with the recommendation engine and the database to:
detect an action;
identify a user associated with the action;
identify one or more audience definitions that include the user;
identify one or more recommendation definitions associated with the identified audience definitions;
select a recommendation definition from the identified recommendation definitions; and
serve the respective recommendation to the user based on the selected recommendation definition.

23. The database system of claim 22, wherein the user to whom the recommendation is served is a user within the organization.

24. The database system of claim 22, wherein the user to whom the recommendation is served is a user external to the organization.

25. The database system of claim 22, wherein the recommendation is served as a feed item in a social networking feed.

26. The database system of claim 22, wherein recommendation engine is configurable to:
prioritize the recommendation definitions in the identified recommendation definitions; and
select the recommendation definition having the highest priority.

27. The database system of claim 26, wherein the recommendation engine is configurable to prioritize the recommendation definitions based on one or more associated audience definitions.

28. The database system of claim 26, wherein the recommendation engine is configurable to prioritize the recommendation definitions based on one or more associated scheduling policies.

29. The database system of claim 26, wherein the recommendation engine is configurable to prioritize the recommendation definitions for the user based a determined level of engagement of the user with a social network.

30. The database system of claim 26, wherein the recommendation engine is configurable to prioritize the recommendation definitions based on historical data collected on previous servings of recommendations associated with one or more of the identified recommendation definitions.
